(19) United States
(12) Patent Application Publication
(10) Pub. No.: US 2026/0368762 A1
(43) Pub. Date: Nov. 19, 2026

(54) SYSTEM AND METHOD FOR INFERRING USER EVENT PREFERENCES THROUGH AGENTIC COMMERCE AND ENRICHED TRANSACTION CONTEXT

(71) Applicant: Visa International Service Association, San Francisco, CA (US)

(72) Inventor: Adam Holt, Santa Clara, CA (US)

(73) Assignee: Visa International Service Association, San Francisco, CA (US)

(21) Appl. No.: 19/680,002

(22) Filed: May 18, 2026

Related U.S. Application Data
(60) Provisional application No. 63/807,359, filed on May 16, 2025.

(51) Int. Cl. G06Q 30/0201; G06N 5/048

(52) U.S. Cl. CPC G06Q 30/020112; G06N 5/048

(57) ABSTRACT

A system and method are provided for generating consumer interest profiles based on event-related transactions. The method, executed by a payment network includes receiving transaction data identifying a third-party merchant and a timestamp associated with a purchase made by a user at an event, determining an event location associated with the third-party merchant by executing a fuzzy-matching algorithm against a location-merchant mapping database, and identifying the event associated with the event location and timestamp by executing a temporally-constrained query against an event-location calendar database to identify an event record. Event metadata associated with the event record is retrieved, and a consumer preference signal associating the user with the event record and the event metadata is generated and stored for use in generating a recommendation or offer for the event or a future event.

### CROSS-REFERENCE TO RELATED APPLICATION

This application claims the benefit of and priority under 35 U.S.C. § 119(e) to U.S. Provisional Application No. 63/807,359, filed May 16, 2025, entitled SYSTEM AND METHOD FOR INFERRING USER EVENT PREFERENCES THROUGH AGENTIC COMMERCE AND ENRICHED TRANSACTION CONTEXT, the contents of which is hereby incorporated by reference in its entirety herein.

### TECHNICAL FIELD

The present disclosure relates generally to data enrichment and user profiling systems, and more particularly to systems and methods for inferring user interests and event attendance patterns by correlating transaction data with publicly available event, venue, and content metadata using agent-based reasoning and machine learning technologies.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for generating consumer interest profiles based on event-related transactions. The method includes receiving, by a payment network, transaction data identifying a third-party merchant and a timestamp associated with a purchase made by a user at an event; determining, by the payment network, an event location associated with the third-party merchant by executing a fuzzy-matching algorithm against a location-merchant mapping database; identifying, by the payment network, the event associated with the event location and timestamp by executing a temporally-constrained query against an event-location calendar database to identify an event record; retrieving, by the payment network, event metadata associated with the event record; generating and storing, by the payment network, a consumer preference signal associating the user with the event record and the event metadata; and generating, by the payment network, a personalized recommendation or offer for the event or a future event based on the consumer preference signal.

In some aspects, the method further includes querying, by a language-based artificial intelligence (AI) model operatively coupled to the payment network, an event-type database to identify an event-type associated with the event location and the timestamp, wherein the event metadata includes at least an event-type and one or more event descriptors. Querying the event-type database may include prompting, by the payment network, the language-based AI model with a location identifier and timestamp to generate a search query; executing, by the language-based AI model, the search query against publicly available sources; evaluating, by the language-based AI model, a relevance of retrieved results; and adaptively modifying, by the language-based AI model, the search query based on result sparsity or excess until converging on a set of event descriptors for the event location and timestamp.

In some aspects, the method further includes classifying, by the language-based AI model, the event into an event-type by applying a classification model to temporal-proximity data, merchant category code data, and event-type database records associated with the event location and the timestamp. Where two or more candidate events are identified as plausible for the event location and timestamp, the method includes generating a ranked set of candidate events with associated confidence scores.

In some aspects, the event metadata for an event with two or more participants includes the event-type, a first participant identifier, and at least a second participant identifier. The method may further include storing a first event-type preference signal associating the user with the event-type, the first participant identifier, and at least the second participant identifier; and upon identifying at least a second event-type preference signal of a same event-type for the user, computing an intersection of participant identifiers across the at least first and second event-type preference signals to identify a candidate preferred participant identifier common to the first and the second event-type preference signals. Computing the intersection may include identifying a first participant set including the first participant identifier and at least the second participant identifier of the event; identifying a second participant set including a third participant identifier and at least a fourth participant identifier of a second event for a same event-type; and determining whether a participant identifier appears in both the first participant set and the second participant set, and if so, designating that participant identifier as the candidate preferred participant identifier.

In some aspects, the method further includes generating a hierarchical tag taxonomy for the user based on the event metadata, wherein the hierarchical tag taxonomy encodes a plurality of tags organized in a multi-level hierarchy proceeding from a broad event category to one or more specific event descriptors, and wherein each tag in the hierarchical tag taxonomy is associated with a machine-learning-maintained confidence score. Upon receipt of each new transaction corresponding to a new inferred event, the method may include updating the hierarchical tag taxonomy by increasing a confidence score for each tag that is reinforced by the new inferred event and decreasing a confidence score for each pre-existing tag that is not reinforced by the new inferred event.

In some aspects, the method further includes pseudonymizing the consumer preference signal and storing the consumer preference signal as a tokenized identifier associated with the user. The method may further include prompting, by the payment network, a language-based AI model with the event location and the timestamp to generate a search query; executing, by the language-based AI model, the search query to retrieve public event data; evaluating a relevance of results using threshold criteria; adaptively modifying the search query based on result sparsity or excess; converging on a set of event descriptors for the event location and timestamp; and associating the set of event descriptors with a user transaction to update the consumer preference signal.

In one general aspect, a system for generating consumer interest profiles based on event-related transactions includes a payment network configured to receive transaction data identifying a third-party merchant and a timestamp associated with a purchase made by a user at an event; determine an event location associated with the third-party merchant by executing a fuzzy-matching algorithm against a location-merchant mapping database; identify the event associated with the event location and timestamp by executing a temporally-constrained query against an event location calendar database to identify an event record; retrieve event metadata associated with the event record; query, using a language-based AI model, an event-type database to identify an event-type associated with the event location and the timestamp; generate and store a consumer preference signal associating the user with the event record, event-type, and the event metadata; and generate a personalized recommendation or offer for the event or a future event based on the consumer preference signal. The system further includes a language-based AI model operatively coupled to the payment network, the language-based AI model configured to receive the query from the payment network; execute the query against publicly available sources; evaluate a relevance of retrieved results; adaptively modify the query based on result sparsity or excess until converging on a set of event descriptors for the event location and timestamp; and return an event-type associated with the event location and the timestamp.

In some aspects of the system, the language-based AI model is further configured to generate a hierarchical tag taxonomy for the user based on the event metadata, wherein the hierarchical tag taxonomy encodes a plurality of tags organized in a multi-level hierarchy proceeding from a broad event category to one or more specific event descriptors, and wherein each tag is associated with a machine-learning-maintained confidence score. Upon receipt of each new transaction corresponding to a new inferred event, the language-based AI model may update the hierarchical tag taxonomy by increasing a confidence score for each tag reinforced by the new inferred event and decreasing a confidence score for each pre-existing tag not reinforced by the new inferred event. The payment network may be further configured to pseudonymize the consumer preference signal and store the consumer preference signal as a tokenized identifier.

In yet another aspect, a method for generating consumer interest profiles based on event-related transactions includes receiving, by a payment network, transaction data identifying a third-party merchant and a timestamp associated with a purchase made by a user at an event of a known event-type; determining, by a language-based AI model associated with the payment network, an event location associated with the third-party merchant based on a location-merchant mapping database; identifying, by the language-based AI model, the event and a participant associated with the event location and timestamp based on an event location calendar database; retrieving, by the language-based AI model, a sub-type descriptor associated with the participant from a participant-descriptor database; generating and storing, by the payment network, a consumer preference signal associating the user with the identified participant and sub-type descriptor; and generating, by the payment network, a personalized recommendation or offer for the event or a future event based on the consumer preference signal.

In some aspects, the method further includes pseudonymizing the consumer preference signal and storing the consumer preference signal as a tokenized identifier. The language-based AI model may generate a summary table for the user indicating a count of participants or sub-types attended over a time window for the known event-type. The method may further include parsing, by the language-based AI model, a sub-type label from public data or reviews of the participant, wherein the sub-type descriptor includes the parsed sub-type label. The location-merchant mapping may include address matching or name similarity scoring performed by the language-based AI model. The method may further include generating a hierarchical tag taxonomy for the user based on the identified participant and sub-type descriptor, wherein the hierarchical tag taxonomy encodes a plurality of tags organized in a multi-level hierarchy proceeding from a sub-type descriptor to the identified participant, and wherein each tag is associated with a machine-learning-maintained confidence score. The method may further include prompting the language-based AI model with the event location and the timestamp to generate a search query; executing the search query to retrieve public event data; evaluating a relevance of results using threshold criteria; adaptively modifying the search query based on result sparsity or excess; converging on a set of event descriptors for the event location and timestamp; and associating the set of event descriptors with a user transaction to update the consumer preference signal.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates an enrollment process for capturing user consent and issuing a data token in accordance with at least one aspect of the present disclosure.

FIG. 2 illustrates a generalized process flow for inferring user interests and event attendance patterns by correlating transaction data with publicly available event, venue, and content metadata through agent-based reasoning and machine learning techniques in accordance with at least one aspect of the present disclosure.

FIG. 3 illustrates a process for constructing and maintaining a venue-merchant matching database in accordance with at least one aspect of the present disclosure.

FIG. 4 illustrates a process for constructing and maintaining a venue calendar–artist matching database in accordance with at least one aspect of the present disclosure.

FIG. 5 illustrates a process for constructing and maintaining an artist–genre database in accordance with at least one aspect of the present disclosure.

FIG. 6 illustrates a process for constructing and maintaining a consumer–music preferences database in accordance with at least one aspect of the present disclosure.

FIG. 7 illustrates a payment network system in accordance with at least one aspect of the present disclosure.

FIG. 8 is a block diagram of a computer apparatus with data processing subsystems or components in accordance with at least one aspect of the present disclosure.

FIG. 9 is a diagrammatic representation of an example computer system that includes a host machine within which a set of instructions to perform any one or more of the methodologies discussed herein may be executed in accordance with at least one aspect of the present disclosure.

FIG. 10 is a logic flow diagram of a method for generating consumer interest profiles based on event-related transactions in accordance with at least one aspect of the present disclosure.

FIG. 11 illustrates a multi-module data-enrichment pipeline architecture operating within a payment network infrastructure in accordance with at least one aspect of the present disclosure.

### DESCRIPTION

The following disclosure may provide example systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms that may be used herein are provided below.

Access Device: A device that enables communication with a remote system, such as a merchant computer or transaction processor. It may include point-of-sale (POS) terminals, smartphones, tablets, PCs, kiosks, ATMs, and similar hardware. Communication may be via contact or contactless methods (e.g., near field communication (NFC), radio frequency (RF), optical, magnetic stripe). A mobile device used as a POS terminal may be called a mobile POS (mPOS) terminal.

Agentic commerce: A model of digital commerce in which autonomous AI agents act on behalf of users to make decisions, initiate purchases, and complete transactions, all based on the user's preferences, consent, and objectives. In this model, AI agents operate with a high degree of autonomy, proactively searching for, recommending, or purchasing products and services that align with the user's needs. These agents rely heavily on user-centric personalization, drawing from a combination of explicit user instructions, historical behavior, and individual preferences to make informed decisions. A critical component of agentic commerce is the privacy-conscious and consent-driven exchange of signals between commercial platforms—such as marketplaces and payment providers—and AI agents. These signals may include user preferences, behavior patterns, and budget constraints, enabling agents to act in a way that respects the user’s intent and privacy. Agentic commerce supports a fully streamlined transaction experience. AI agents can manage the entire purchasing workflow, which may include authenticating the user, comparing products, executing payments, and even coordinating delivery. This hands-free, intelligent approach redefines how consumers interact with digital commerce by shifting agency from the user to a trusted AI assistant.

AI Agent: A software-based entity capable of perceiving its environment, reasoning over data, and autonomously taking actions to achieve specific goals on behalf of a user or system. These agents are defined by their autonomy, operating without constant human supervision; their goal-directed behavior, acting in pursuit of user-defined or learned objectives; and their ability to learn and adapt over time based on new information or feedback. They also interact with their environment by gathering inputs—such as signals, data, or contextual cues—and influencing systems through actions like initiating purchases, scheduling meetings, or querying APIs. In the context of agentic commerce, AI agents can play a highly active role. For example, an agent might monitor price drops on products the user is interested in, evaluate product reviews, seek approval, when necessary (or proceed according to preset user preferences), and complete a purchase securely managing the entire transaction process. “AI agent” also may refer more broadly to agent-based platforms or providers, sometimes called AI assistant providers or generative AI platforms. Examples include companies and services like OpenAI (which offers ChatGPT), Anthropic (creator of Claude), Perplexity (an AI-powered search and answer engine), and Grok by xAI (a model known for performance in math, science, and coding). Depending on context, these platforms may be described as generative AI services, LLM-based tools, conversational AI systems, or agentic AI frameworks—emphasizing their ability to generate responses, engage in dialogue, or act with varying degrees of autonomy. These platforms go beyond simple large language model (LLM) interactions, supporting more complex, goal-oriented behaviors that are integral to the emerging ecosystem of agentic AI.

Application: Software that performs specific functions when executed by a processor. A mobile application runs on a mobile device, while a payment application stores and provides account credentials. A wallet application may manage multiple accounts. Applications may include application programming interfaces (APIs) or graphical user interfaces (GUIs) that enable interaction between system components.

Client / Client Device: A client is an entity (e.g., merchant or acquirer) that uses a client device to initiate transactions. A client device is any network-connected electronic device—such as a phone, POS terminal, wearable, or smart appliance—used to communicate with remote systems.

Communication / Communicate: Refers to the sending or receiving of information (e.g., data, signals, messages) between systems or components, either directly or via intermediaries. Communications may be wired or wireless.

Comprising: A transitional term meaning “including” or “containing,” used in claims to indicate that additional elements or steps may be present. Unlike “consisting of,” it is open-ended and inclusive.

Computing Device: Any electronic device capable of network communication and data processing. This includes mobile devices (e.g., phones, tablets, and wearables) and non-mobile devices (e.g., desktop computers). A computing device typically has a processor, memory, network interface, and input/output components.

Consumer: An individual associated with one or more personal accounts or devices. Also referred to as a user, cardholder, or account holder. Consumer and user may be used interchangeably.

Credential: Information used to verify identity, ownership, or authority, such as passwords, access cards, ID documents, or login credentials.

Data Token: A data token represents user data access rights, privacy control, or consent and may be used for managing authorization to share or use data (e.g., with third parties, AI agents, apps). They are used in the context of data privacy, consent management, agentic commerce, AI personalization. As an example, a data token may be used to grant an AI assistant permission to use user information.

Device-Specific Tokens: Tokens can be tied to specific devices. If a token is used on a different device from the one it was provisioned to, the transaction may be flagged as fraudulent. One PAN may correspond to multiple tokens across different devices. Tokens may also have overlapping time-to-live (TTL) durations and be dynamically issued in sets.

Interface: Software that processes communications. An interface may receive and respond to requests in a specific format. Examples include APIs and GUIs, which may be tailored to particular entities or use cases.

Issuer Identification via Token Format: Token formats may include issuer identifiers (e.g., token bank identification numbers (BINs)) that enable payment systems to identify the issuer. A token BIN may be mapped to an issuer's actual BIN, and issuer identifier ranges can be shared in routing tables for compatibility with existing payment flows.

Online Purchase: A transaction for a digital or physical product or service conducted over a network, such as the internet.

Payment Device: Any device used to conduct a financial transaction, including credit/debit cards, smartphones, personal digital assistants (PDAs), wearables, and digital wallets. Payment devices may operate in contact or contactless modes and can be physical (e.g., magnetic stripe cards) or virtual (e.g., stored credentials in apps).

Payment Network: An electronic system that facilitates the acceptance, transmission, and processing of payment transactions. It connects issuers, acquirers, merchants, and consumers. Example: VisaNet.

Payment Processing Network: A system that receives and settles transaction data, calculates credits/debits, and updates accounts. Example: Interlink®.

Payment Token: Represents a payment credential and may be a substitute for a real account number (e.g., PAN) used to enhance security. Tokens resemble real account numbers but cannot be used to deduce the original PAN. They may be format-preserving and device-specific.

Payment Token Issuer Identifier: A unique identifier (e.g., a token BIN) that maps a token to its issuer. Identifiers may be static and used for routing and association with issuer BINs across token ranges.

Processing Network: A system that handles the transfer of transaction data between parties, such as issuers, acquirers, merchants, and device users.

Product: A good or service offered by a merchant.

Provisioning: The act of delivering or enabling data (e.g., tokens) on a device. Tokens can be provisioned by issuers, payment networks, or other systems and stored in a token vault.

Server Computer: A powerful machine or group of machines that process requests from client devices. It may host databases, services, or applications, and can be used by payment networks, issuers, or merchants.

System: One or more interconnected computing devices, components, or applications that work together to perform tasks or processes.

Token: A data element that replaces sensitive account information (like a PAN) to improve transaction security.

Tokenization: The process of replacing real data with tokens. Enhances privacy and protects credentials during processing.

Token Attributes: Metadata about a token, such as usage limits, expiration date, device ID, and wallet ID. Attributes define how tokens behave and are validated.

Token Service System: A system that generates, manages, and maps tokens to PANs. It supports de-tokenization and sets assurance levels for token authenticity.

Transaction Amount: The monetary value of a transaction. Rules can be applied to specific ranges or thresholds (e.g., routing rules for transactions over $100).

Transaction Data: Information related to a transaction, including account identifiers, products purchased, consumer details, and tokens. May be collected in real-time or stored.

Transaction Service Provider: An entity that processes transaction requests and guarantees payments, often through agreements with issuers. Includes systems run by networks like Visa or Mastercard.

User: An individual associated with personal accounts or devices. Also referred to as a consumer, account holder, or cardholder. User and consumer and may be used interchangeably.

User Device: An electronic device used by a user to connect to a network. Examples include smartphones, laptops, wearables, and internet-connected vehicles.

User Information: Data associated with a user, such as account credentials or device identifiers. May include unique fingerprints generated by software development kits (SDKs) based on device attributes (e.g., International Mobile Equipment Identity (IMEI), operating system (OS) version).

With the emergence of large language models (LLMs) and generative AI platforms, users increasingly rely on agents to perform tasks including search, recommendation, and purchase. However, these agents lack direct access to a user's transactional history and preferences unless they are integrated with contextual sources. Payment networks process billions of transactions and are uniquely positioned to provide insights, or "signals," that can significantly improve agent personalization.

Digital assistants and artificial intelligence (AI) agents increasingly assist users with a variety of tasks, including but not limited to commerce-related activities such as planning purchases, comparing offers, and executing transactions. However, these agents often lack deep personalization or access to user-specific contextual information, such as transactional history, behavioral patterns, and evolving preferences, thereby limiting their effectiveness. There is a need for a system that can autonomously act on behalf of users in a wide range of interactions, such as responding to clarification requests, planning itineraries, or coordinating services, while respecting data privacy and accurately reflecting the user's evolving preferences.

The present disclosure provides a system and method for inferring user event preferences through agentic commerce and enriched transaction context. Traditional commerce systems are limited in their ability to extract meaningful user preference signals from real-world events, especially where user intent or interests are not explicitly declared. For example, purchases at live events provide valuable transactional signals, but such data alone often lacks the necessary context to infer what event was attended or what artist, team, or topic was involved.

A specific technical problem arises in data-enrichment systems operating within payment network architectures: how to transform raw, semantically impoverished transaction records, which contain only a third-party merchant identifier and a timestamp, into structured, semantically enriched consumer preference signals that reflect real-world event attendance and associated interests, without requiring direct access to ticket-purchase records or explicit user-declared preferences. Payment transactions at event venues (e.g., concession purchases, souvenirs, parking, box offices, and other third-party vendors) are processed by payment networks as undifferentiated retail transactions, and the payment network's processing pipeline has no native mechanism to resolve a third-party merchant identifier to a live event, a performing artist, a sports team, farmers markets, or any other event-specific contextual datum. Solving this technical problem requires a coordinated, multi-stage data-enrichment architecture that operates across heterogeneous data sources including but not limited to public event calendars, ticketing databases, artist biographical databases, and sports league scheduling systems while maintaining data-processing efficiency and preserving consumer privacy through pseudonymization and consent management.

Thus, ticket purchases, when observable, are often anonymized through ticketing platforms and do not lend themselves to downstream consumer profiling. Thus, a technical problem exists as to how to infer a user’s event interests and build a persistent, privacy-preserving preference profile using only partial and indirect data such as payment transactions at event locations (e.g. a venue).

The present disclosure addresses this technical problem by providing a multi-module AI-driven data-enrichment pipeline, operating within a payment network server infrastructure. The system and method include resolving a third-party merchant identifier from a payment transaction to an event location identifier using a composite fuzzy-matching algorithm, resolving the event location identifier and transaction timestamp to a specific event record using a temporally-constrained query against a maintained event location calendar database, where the query is generated and adaptively refined by a pre-trained LLM agent. The system and method additionally include retrieving and applying structured event metadata, including event-type, participant identifiers, and sub-type descriptors, to enrich the raw transaction record and generating and persistently storing a pseudonymous consumer preference signal encoded as a confidence-weighted hierarchical tag record indexed by a payment-network-issued data token. This technical solution produces, from a single anonymized transaction data, a structured, privacy-preserving, semantically enriched consumer preference record that can be used to drive downstream AI agent personalization and targeted offer delivery.

The present disclosure relates to systems and methods for generating consumer interest profiles derived from event-related financial transactions. More particularly, the present disclosure concerns the use of a payment network, in conjunction with a language-based artificial intelligence model, to infer the nature of events attended by users based on transaction data, and to construct structured consumer preference signals that capture enriched contextual information about those events. By processing transaction data generated in the ordinary course of commerce, the disclosed systems and methods enable the automated construction of consumer interest profiles without requiring affirmative input from the user, thereby providing a passive, scalable, and privacy-conscious mechanism for characterizing consumer preferences.

The present disclosure relates to systems and methods for generating consumer interest profiles by inferring, from payment transaction data received by a payment network, events attended by a user, and generating consumer preference signals that associate the user with inferred event records and corresponding event metadata derived therefrom.

In one embodiment, the present disclosure provides a method for generating consumer interest profiles based on event-related transactions. The method begins when a payment network receives transaction data associated with a purchase made by a user at an event. The transaction data identifies a third-party merchant at which the purchase was made and includes a timestamp corresponding to the time of the transaction. Because the third-party merchant may be a vendor, concessionaire, or other commercial operator present at or in proximity to an event venue, the identity of the merchant and the time of the transaction together serve as inputs from which the event may be inferred.

Upon receiving the transaction data, the payment network proceeds to determine an event location associated with the third-party merchant. This determination is accomplished by executing a fuzzy-matching algorithm against a location-merchant mapping database. The fuzzy-matching algorithm accommodates variations in merchant name representation, partial address information, and other imprecision that may exist in the transaction data, thereby enabling robust identification of the geographic location associated with the merchant even where exact string matching would fail. The resulting event location provides the geographic anchor upon which subsequent event identification steps rely.

Having determined the event location, the payment network identifies the specific event associated with that location and the timestamp by executing a temporally-constrained query against an event-location calendar database. The temporally-constrained query is structured to retrieve event records that are associated with the identified event location and that fall within a temporal window encompassing the timestamp of the transaction. The query returns an event record corresponding to the event that was taking place at the identified location at the relevant time. The payment network then retrieves event metadata associated with the identified event record. The event metadata may include descriptors characterizing the nature, category, and attributes of the event.

Once the event metadata has been retrieved, the payment network generates and stores a consumer preference signal. The consumer preference signal associates the user with the event record and the event metadata, thereby recording an inference that the user attended or participated in the identified event. This consumer preference signal forms the foundational data structure from which consumer interest profiles are constructed and refined over time as additional transactions are processed.

The present disclosure further relates to systems and methods for identifying an event-type associated with an inferred event by operatively coupling a language-based artificial intelligence model to a payment network. The language-based AI model receives a query comprising an event location and a timestamp, executes the query against publicly available sources, adaptively refines the query based on result sparsity or excess, and returns an event-type and one or more event descriptors to the payment network for incorporation into a consumer preference signal.

In one embodiment, the method additionally comprises querying, by a language-based AI model that is operatively coupled to the payment network, an event-type database to identify an event-type associated with the event location and the timestamp. In this embodiment, the event metadata comprises at least an event-type and one or more event descriptors that more granularly characterize the nature of the event.

The process by which the language-based AI model queries the event-type database is initiated by the payment network, which prompts the language-based AI model with a location identifier and the timestamp in order to generate a search query tailored to the specific event location and time. The language-based AI model executes the generated search query against publicly available sources and evaluates the relevance of the results retrieved in response to that query. Where the results are insufficient in number or specificity, that is, where result sparsity is detected, the language-based AI model adaptively modifies the search query to broaden the scope of retrieval. Conversely, where an excess of results is returned, the language-based AI model narrows the search query to improve precision. This adaptive modification process continues iteratively until the language-based AI model converges on a set of event descriptors that adequately characterizes the event associated with the identified event location and timestamp.

In a related embodiment, the payment network itself prompts the language-based AI model with the event location and the timestamp to generate a search query, which the language-based AI model then executes to retrieve public event data. The language-based AI model evaluates the relevance of the retrieved data against threshold criteria and adaptively modifies the search query based on result sparsity or excess, converging on a set of event descriptors for the event location and timestamp. The language-based AI model then associates the derived set of event descriptors with the user's transaction in order to update the consumer preference signal with the enriched event characterization.

The present disclosure further relates to systems and methods for classifying an inferred event into an event-type by applying a classification model to temporal-proximity data, merchant category code data, and event-type database records associated with an identified event location and timestamp, and, where two or more candidate events are determined to be plausible for the event location and timestamp, generating a ranked set of candidate events each associated with a confidence score reflecting the relative likelihood that the respective candidate event corresponds to the event attended by the user.

In a further embodiment, where the event associated with a given event location and timestamp is not uniquely determinable from available data, the language-based AI model classifies the event into an event-type by applying a classification model to a combination of inputs. These inputs include temporal-proximity data, which captures the timing relationship between the transaction and known events in the vicinity; merchant category code data, which reflects the commercial nature of the transacting merchant; and event-type database records associated with the event location and the timestamp. By synthesizing these inputs through the classification model, the language-based AI model derives an event-type classification that reflects the most probable nature of the event.

Where the classification process results in the identification of two or more candidate events that are each plausible for the identified event location and timestamp, the language-based AI model does not arbitrarily select among them. Instead, it generates a ranked set of candidate events, each accompanied by an associated confidence score that reflects the relative likelihood that the candidate event corresponds to the actual event attended by the user. This ranked output allows downstream processes to handle uncertainty in a principled manner, preserving the most probable event characterizations while retaining lower-ranked candidates for potential refinement upon receipt of additional data.

The present disclosure further relates to systems and methods for identifying participants associated with inferred events and deriving a candidate preferred participant identifier therefrom, wherein, for each inferred event comprising two or more participants, an event-type preference signal is stored associating the user with the event-type and the respective participant identifiers of the event, and, upon identifying at least a second event-type preference signal of the same event-type for the user, a language-based artificial intelligence model computes an intersection of participant identifiers across the stored event-type preference signals to identify a candidate preferred participant identifier that is common to two or more such signals.

In some embodiments, the participant may be an artist, a speaker, an act, a performer, or other individual(s) identified as part of the event. In some embodiments, the participant may include two or more participants, such as sporting contests, debates, performances involving multiple acts, or similar multi-party events.

In a further embodiment directed to events comprising two or more participants, such as sporting contests, debates, performances involving multiple acts, or similar multi-party events, the event metadata associated with such an event includes the event-type, a first participant identifier, and at least a second participant identifier. When such event metadata is retrieved, the language-based AI model stores a first event-type preference signal that associates the user with the event-type, the first participant identifier, and at least the second participant identifier of the event.

Upon the subsequent identification of at least a second event-type preference signal of the same event-type for the same user, the language-based AI model computes an intersection of participant identifiers across the first event-type preference signal and the second event-type preference signal. This intersection operation is carried out by identifying a first participant set comprising the participant identifiers associated with the first event and a second participant set comprising the participant identifiers associated with the second event of the same event-type. The language-based AI model then determines whether any participant identifier appears in both the first participant set and the second participant set. Upon determining that a participant identifier is common to both sets, the language-based AI model designates that participant identifier as a candidate preferred participant identifier for the user. This inference rests on the rationale that a user who has attended multiple events of the same type at which a particular participant was present is more likely to have a preference for that participant than for participants who appeared in only one of the relevant events.

The present disclosure further relates to systems and methods for generating, by a language-based artificial intelligence model, a hierarchical tag taxonomy for a user based on event metadata associated with inferred events. The hierarchical tag taxonomy encodes a plurality of tags organized in a multi-level hierarchy proceeding from a broad event category to one or more specific event descriptors, each tag being associated with a machine-learning-maintained confidence score, and wherein the hierarchical tag taxonomy is dynamically updated upon receipt of each new transaction corresponding to a new inferred event by increasing a confidence score for each tag reinforced by the new inferred event and decreasing a confidence score for each pre-existing tag not reinforced by the new inferred event, such that the hierarchical tag taxonomy evolves over time as an adaptive and current representation of the user's consumer preferences.

In a further embodiment, the language-based AI model generates, for the user, a hierarchical tag taxonomy based on the event metadata associated with events inferred from the user's transactions. The hierarchical tag taxonomy encodes a plurality of tags organized in a multi-level hierarchy that proceeds from a broad event category at its highest level down to one or more specific event descriptors at lower levels of the hierarchy. Each tag in the hierarchical tag taxonomy is associated with a machine-learning-maintained confidence score that reflects the degree to which the tag accurately represents the user's interests based on the transactions processed to date.

The hierarchical tag taxonomy is not a static data structure. Rather, it is updated dynamically upon the receipt of each new transaction that corresponds to a new inferred event. When such a transaction is received, the language-based AI model updates the hierarchical tag taxonomy by increasing the confidence score for each tag that is reinforced by the new inferred event, thereby strengthening the association between the user and the corresponding interest category or descriptor. At the same time, the language-based AI model decreases the confidence score for each pre-existing tag in the hierarchical tag taxonomy that is not reinforced by the new inferred event, thereby introducing a decay mechanism that allows the taxonomy to adapt over time to reflect changes in the user's demonstrated interests. Through this bidirectional updating process, the hierarchical tag taxonomy evolves as an increasingly accurate and current representation of the user's consumer preferences.

The present disclosure further relates to systems and methods for preserving the privacy of a user whose transactions are processed in connection with consumer interest profile generation, wherein the payment network pseudonymizes the consumer preference signal generated for the user and stores the pseudonymized consumer preference signal as a tokenized identifier associated with the user, such that the consumer preference signal may be utilized for downstream processing and analysis without exposing the identity of the user and in a manner compatible with privacy-preserving data governance frameworks.

In a further embodiment, the payment network pseudonymizes the consumer preference signal and stores the pseudonymized consumer preference signal as a tokenized identifier associated with the user. By substituting a tokenized identifier for personally identifying information at the point of storage, the method ensures that the consumer preference signal may be utilized for downstream processing and analysis without exposing the identity of the user. This pseudonymization step is compatible with privacy-preserving data governance frameworks and enables the dissemination and use of consumer interest profile data in contexts where direct user identification would be impermissible or undesirable.

In a further aspect, the present disclosure is embodied as a system for generating consumer interest profiles based on event-related transactions. The system comprises a payment network and a language-based AI model that is operatively coupled to the payment network. The payment network is configured to receive transaction data identifying a third-party merchant and a timestamp associated with a purchase made by a user at an event, and to determine the event location associated with the third-party merchant by executing a fuzzy-matching algorithm against a location-merchant mapping database. The payment network further executes a temporally-constrained query against an event-location calendar database to identify an event record corresponding to the event associated with the event location and timestamp, and retrieves the event metadata associated with that event record. The payment network transmits a query comprising the event location and the timestamp to the language-based AI model for the purpose of identifying an event-type associated with the event location and timestamp. Upon receiving the event-type from the language-based AI model, the payment network generates and stores a consumer preference signal that associates the user with the event record, the event-type, and the event metadata.

The language-based AI model, for its part, is configured to receive the query transmitted by the payment network, execute that query against publicly available sources, and evaluate the relevance of the results retrieved in response. Where the results are insufficient or excessive, the language-based AI model adaptively modifies the query until it converges on a set of event descriptors for the event location and timestamp. The language-based AI model then returns the identified event-type to the payment network for incorporation into the consumer preference signal.

In a further embodiment of the system, the language-based AI model is additionally configured to generate the hierarchical tag taxonomy for the user as described above, and to update that taxonomy upon the receipt of each new transaction corresponding to a new inferred event by increasing confidence scores for reinforced tags and decreasing confidence scores for tags that are not reinforced by the new event. In a still further embodiment of the system, the payment network is additionally configured to pseudonymize the consumer preference signal and to store it as a tokenized identifier associated with the user.

The present disclosure further relates to systems and methods for generating consumer interest profiles in contexts where the event-type associated with a transaction is known at the time the transaction is received. A language-based AI model associated with the payment network determines an event location associated with a third-party merchant by reference to a location-merchant mapping database, identifies the event and a participant associated with the event location and timestamp by reference to an event-location calendar database, retrieves a sub-type descriptor associated with the identified participant from a participant-descriptor database, and wherein the payment network generates and stores a consumer preference signal associating the user with the identified participant and the sub-type descriptor, thereby enabling the construction of consumer interest profiles that are enriched with participant-level and sub-type-level characterizations of the events attended by the user.

In an alternative embodiment, the present disclosure is implemented as a method for generating consumer interest profiles in contexts where the event-type is already known at the time the transaction is received. In this embodiment, the payment network receives transaction data identifying a third-party merchant and a timestamp associated with a purchase made by a user at an event of a known event-type. The language-based AI model, operating in association with the payment network, determines the event location associated with the third-party merchant by reference to a location-merchant mapping database. The location determination may be accomplished through address matching, which compares address information derived from the transaction data against address records in the location-merchant mapping database, or through name similarity scoring, by which the language-based AI model computes a similarity metric between the merchant name as recorded in the transaction data and merchant names in the mapping database, thereby accommodating variations in name representation.

Having determined the event location, the language-based AI model identifies the specific event and a participant associated with the event location and timestamp, drawing upon an event-location calendar database. The language-based AI model then retrieves, from a participant-descriptor database, a sub-type descriptor associated with the identified participant. The sub-type descriptor provides a more granular characterization of the participant than the event-type alone, encoding information about the specific character or category of the participant within the broader event-type. In one embodiment, the sub-type descriptor includes a sub-type label that the language-based AI model parses from public data or reviews of the participant. By extracting sub-type labels from publicly available sources, such as reviews, editorial content, or classification databases, the language-based AI model is able to generate sub-type descriptors that are rich in semantic content and reflective of how the participant is understood and categorized within the relevant domain.

Upon identifying the participant and retrieving the associated sub-type descriptor, the payment network generates and stores a consumer preference signal associating the user with the identified participant and the sub-type descriptor. As in the primary embodiment, the consumer preference signal may be pseudonymized and stored as a tokenized identifier associated with the user, thereby preserving privacy while enabling downstream use of the preference data.

In a further embodiment, the language-based AI model generates a summary table for the user that indicates, over a defined time window, a count of participants or sub-types that the user has attended for the known event-type. This summary table provides an aggregated view of the user's engagement history with events of the relevant type, enabling the identification of patterns in the user's attendance behavior across participants and sub-type categories.

In a still further embodiment of this alternative method, the language-based AI model generates a hierarchical tag taxonomy for the user based on the identified participant and sub-type descriptor. In this embodiment, the hierarchical tag taxonomy is organized in a multi-level hierarchy that proceeds from the sub-type descriptor at a higher level of abstraction down to the identified participant at a more specific level, with each tag in the taxonomy associated with a machine-learning-maintained confidence score. Additionally, the language-based AI model may be prompted with the event location and timestamp to generate a search query, which it executes to retrieve public event data, evaluates for relevance against threshold criteria, and adaptively modifies based on result sparsity or excess until converging on a set of event descriptors. The resulting event descriptors are then associated with the user's transaction to update the consumer preference signal, thereby enriching the preference record with externally sourced contextual information about the event and its participants.

In one embodiment, this disclosure relates to a system and method for constructing a consumer interest profile based on transactional data captured during purchases at live event locations. An intelligent agent system, referred to as the AI Agent, periodically discovers and updates an interconnected set of databases mapping location, event participants, event-type, and event sub-types (e.g. genres, leagues, etc). For example, artists, performers, teams, and vendors are collectively and individually referred to herein as participants of the event. Databases may include (1) location-merchant association, (2) location-participant-event calendar, (3) participant-type descriptors, and (4) consumer-attendance-inferred preferences.

Using a modular logic pipeline, the agentic system crawls publicly available web data and correlates it with proprietary transaction data. For example, if a user purchases a beverage at a specific event location on a particular date, the system identifies the event location, cross-references it with an artist performing on that date, and extracts genre descriptors. This information is then associated with the user in a privacy-aware manner, using tokenized identities and consent-driven signals.

LLMs enhance this process by dynamically adapting search strategies based on event location names, participant metadata, and event location calendars. The LLM performs iterative queries and adjusts keyword strategies based on result relevance to extract meaningful contextual signals. Over time, the system aggregates event attendance patterns and builds a descriptive profile of user interests, which can be surfaced through controlled APIs to agents or merchants for personalized offers and recommendations.

The technical improvements achieved by the present system and method over conventional transaction-processing and consumer-profiling approaches include inferring event attendance from transaction data without access to ticket-purchase records, which are typically anonymized by ticketing platforms; reducing manual data curation requirements through automated, LLM-driven agentic crawling and relevance evaluation of public event scheduling sources; improving preference-signal accuracy achievable through iterative machine learning (ML) confidence-score updating, whereby the confidence associated with each preference tag is refined with each new event observation rather than being fixed at a single observation; and inferring sports team preference from a minimum of two event observations through an intersection-based set-matching algorithm, enabling team-level preference inference without requiring explicit user declaration.

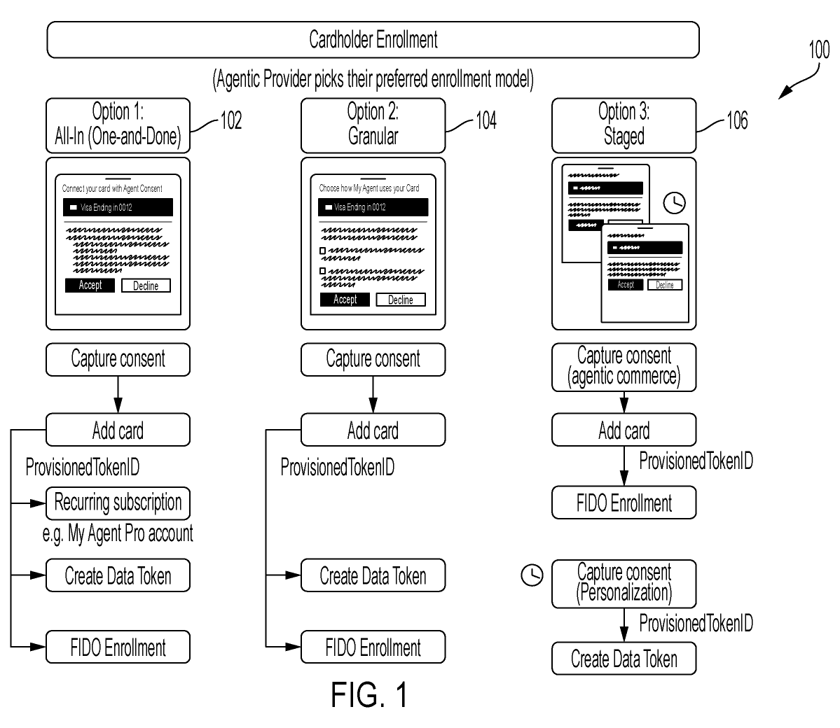

FIG. 1 illustrates an enrollment process 100 for capturing user consent and issuing a data token in accordance with at least one aspect of the present disclosure. These flows illustrate the process of enrolling a cardholder (e.g., user/consumer; throughout this disclosure the term user is used interchangeably with the term consumer) for ongoing agent-enabled commerce. The enrollment flows include three models for enrollment: an All-in model, a granular model, or a staged model. Each model captures a consumer's consent to subscribe to the agent service. It supports adding a card, creating a data token (if needed by a model), enabling Fast Identity Online (FIDO) enrollment, and capturing what consents may be appropriate to a model. This provides the user the flexibility to pick a subscription (model) they prefer and to have the appropriate data token created as part of a FIDO enrollment process.

The agent is also seeking consent to using the payment instrument in order to make online purchases at other merchants. The consent may be a comprehensive all-in-one and done, as indicated in Option 1 (102). It could be granular, as indicated in Option 2 (104), where the user can check on and off individual components. The consent, also may be accomplished in stages, as shown in Option 3 (106), where the agent provider decides to break down the consent process rather than asking the user all in one session. For example, the agent may first ask the user for this bit consent component, and then at some arbitrary point in the future ask the user for this other bit of consent component.

Once the card holder/consumer provides the card details to the payment network, they are tokenized by the payment network. A data token is created by the payment network and is provided back to the user using an existing data token provisioning process. A data token is an access token for the agent provider to be able to go and request the signals. It's a record that the payment network obtained consent from the consumer.

Once the payment network identifies the consumer, it's specific to a particular transaction client of the agent provider. It is not a broad consent for any company out there to obtain signals on this consumer. The record is held by the payment network and the payment network issues the agent a unique reference ID, which is the data token. The agent is then able thereafter to request the specific desired signals and the payment network will provide them to the agent after the agent presents the data token, which is the key that the agent has the right to request such information about the consumer from the payment network.

An API may be used to process the request coming in from the agent provider to the payment network. The request includes the data token identifier, which has already been given to the agent they added a card to. The agent is providing the payment network with a record of the consent that they received. The agent is conveying to the payment network that they received consent from the user. In this case, the agent received the data tokens. The agent also may receive a pass-through token that refers to the agent-based commerce. The idea here is that the payment network is returning a data token identifier to the agent that is a unique key that permits the agent to request signals from the user.

Once the cardholder enrollment process is completed, the system operates as an agentic commerce platform that continuously discovers and enriches contextual information around real-world event transactions. It begins by periodically crawling publicly available data sources to identify newly listed event locations. Upon identifying a new event location, the system performs a fuzzy match against merchant names and addresses found in transaction records to determine which merchants are likely operating within that event location. These merchants are then indexed against the event location in a dedicated database, enabling future correlation.

To build out a deeper contextual framework, the system regularly scans public event calendars associated with each event location to extract scheduled event dates and the names of event participants (e.g. artists, speakers, teams, athletes, performers). This information is stored as structured location-date-participant records. For each participant identified, the system further retrieves biographical data, reviews, and other online materials from public sources. Using natural language processing techniques and LLM-based reasoning, it extracts sub-type descriptors, including but not limited to a genre of music or performance or sport type, which are linked to the respective participant in a participant-descriptor database.

When a transaction is detected within the payment network system at a known event merchant, the system infers the likely event attended by resolving the third-party merchant and timestamp against the event location-calendar mapping and corresponding participant. The sub-type associated with the identified event participant is then used to create a pseudonymized consumer signal, such as an inferred interest in music, which is stored or updated in the user’s preference profile.

As more such events accumulate, the system constructs a comprehensive history of inferred attendances, aggregating them into a consumer-specific summary table that reflects event participants and sub-type engagement over time. This evolving profile supports downstream personalization by enabling tailored recommendations, targeted offers, and audience segmentation based on demonstrated interests.

Consumer privacy is preserved through the use of pseudonymous data tokens. No individual-level data is shared with external parties unless the consumer has explicitly opted in. The entire system is driven by agentic processes and LLM-enabled modules that dynamically generate and refine search queries, assess the relevance of retrieved information, and adapt search parameters accordingly. These components are orchestrated to maintain fresh data across event location calendars, event participant descriptors, and consumer profiles, ensuring a responsive and scalable infrastructure for interest inference and event-based personalization.

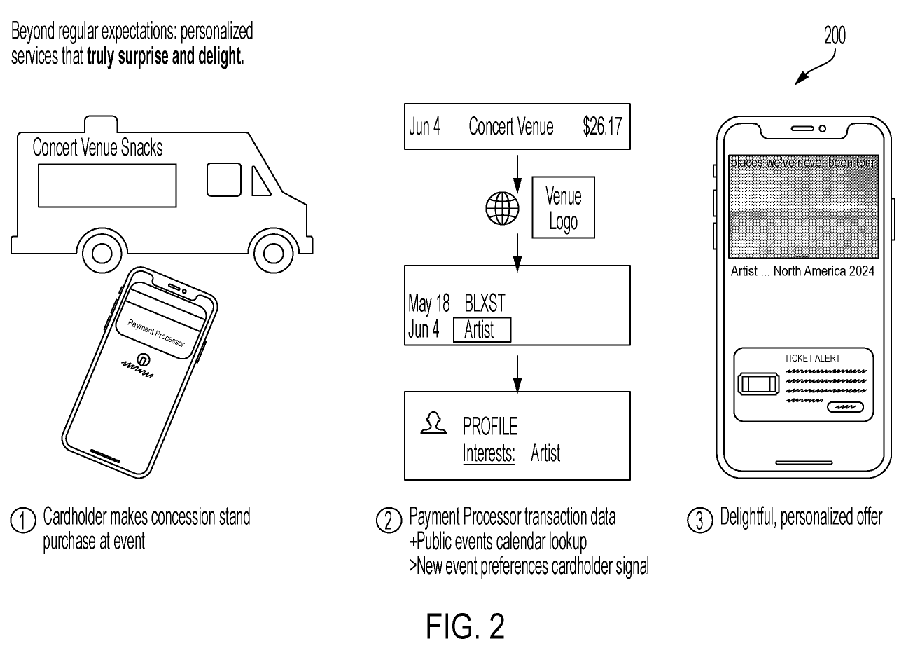

FIG. 2 illustrates a generalized process flow 200 for inferring user interests and event attendance patterns by correlating transaction data with publicly available event, event location, and content metadata through agent-based reasoning and machine learning techniques in accordance with at least one aspect of the present disclosure. The process begins when a cardholder initiates a purchase at a third-party merchant during an event. Upon processing the transaction, the payment network retrieves relevant transaction details, including merchant and timestamp data. Using this information, the system performs a contextual lookup against a public events calendar to infer which event the cardholder likely attended and to identify associated metadata, including but not limited to the performing artist and genre. Based on this inferred event signal, the payment network then generates a personalized recommendation or offer for a future event that aligns with the cardholder's demonstrated interests. This inference-driven personalization allows for more meaningful consumer engagement without requiring explicit input from the user.

The inferred event signal may include a consumer preference signal, generated and stored by the system and/or method. The consumer preference signal may be based to generate a recommendation or offer for vendors or related attractions at the event or future events. The recommendation or offer may be tailored to known events, vendors, or attractions based on the timestamp of the transaction data. The recommendation or offer may be displayed to the consumer by an application notification or digital message and may contain an actionable link or information to make a purchase based on the recommendation or offer. In one aspect, the recommendation or offer may be displayed as a push notification from a banking application associated with the payment network and may include a clickable link to a merchant web-browser associated with an event, vendor, or attraction. In another aspect, the recommendation or offer may be a text message containing a unique code and coupon associated with an event, vendor, or attraction for purchase.

The technological implementation of the system leverages LLM-based agents that dynamically generate search queries and assess the quality of returned results. These agents adapt the scope of their keyword formulations in real time to optimize both precision and recall, enabling more effective extraction of relevant public data. The system performs a cascading sequence of lookups and inferences, beginning with third-party merchant identifiers and transaction dates, which are resolved through event location mappings to identify associated events and event participants. This multi-stage resolution process ensures accurate contextualization of transaction data. Underlying this functionality is an agent orchestration framework that coordinates the periodic updating of key databases, including event location calendars, participant-sub-type descriptors, and individual consumer preference profiles, thereby maintaining the system's responsiveness and data integrity over time.

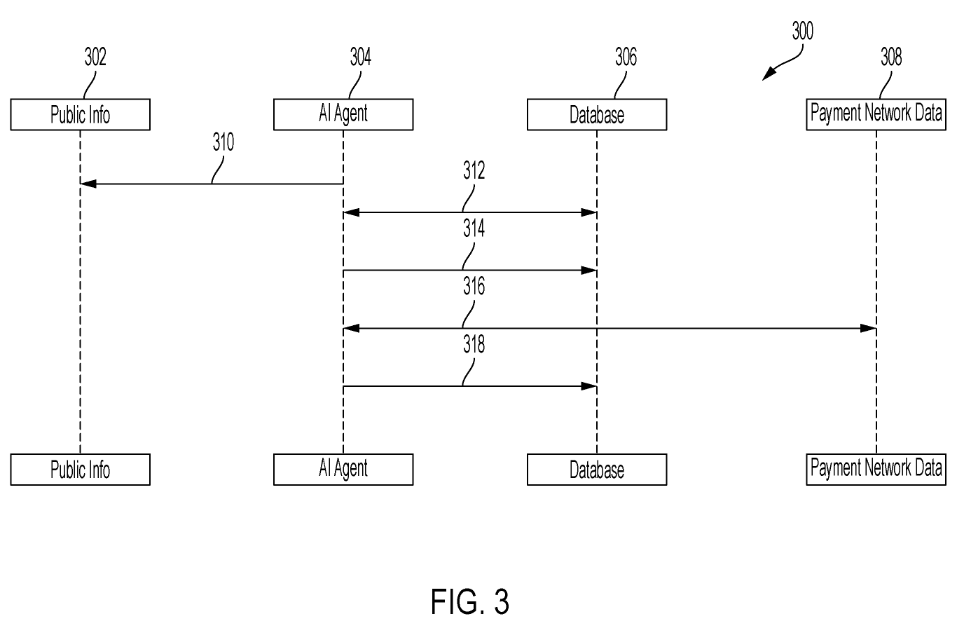

The system’s technological framework enables and supports a series of interrelated processes, depicted in FIGS. 3 - 6, that collectively construct and maintain the underlying data structures necessary for inferring user event preferences. These processes are carried out by AI-driven agents operating within the orchestrated architecture described above, and include the creation and continuous refinement of location–merchant mappings, event location calendars, participant-sub-type associations, and consumer-level preference profiles. Each process builds upon the others to enable accurate, scalable, and privacy-preserving inference of user interests based on real-world transaction activity.

FIG. 3 illustrates a process 300 for constructing and maintaining a location-merchant matching database in accordance with at least one aspect of the present disclosure. This process is executed periodically to ensure the database remains current and enables efficient lookup of event locations based on merchant identifiers.

The process 300 begins at step 310, in which the AI Agent 304 searches publicly available sources (Public Info 302) to discover event locations, capturing key attributes such as event location names and addresses. At step 312, the AI Agent 304 compares the newly obtained event location information against existing entries stored in the Database 306. If the event location does not already exist in the database, the AI agent creates a new record to represent it, as depicted at step 314.

Once a new event location is confirmed and recorded, the process proceeds to step 316, in which the AI Agent 304 queries the payment network data 308 to identify third-party merchants potentially associated with that event location. This is performed using a fuzzy matching technique that accounts for variations in naming and addressing conventions. At step 318, upon identifying one or more merchant matches, the AI agent 304 stores those merchant records in the database 306, indexing them to the corresponding event location. This indexed structure supports downstream operations that rely on resolving event location identities from observed merchant data in payment transactions.

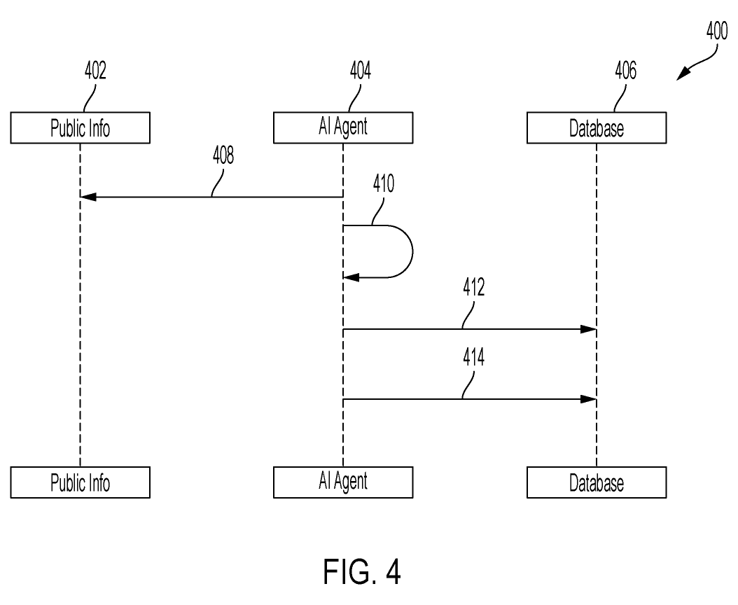

FIG. 4 illustrates a process 400 for constructing and maintaining an event location calendar–participant matching database in accordance with at least one aspect of the present disclosure. To maintain the accuracy and completeness of the database, the process is executed on a recurring basis and supports the downstream ability to resolve event locations based on associated merchant identifiers.

The process 400 begins at step 408, in which the AI agent 404 initiates a search of the publicly available information (Public Info) 402 to discover event calendars associated with known event locations. At step 410, the AI agent 404 parses the retrieved calendar data to extract relevant details, including the names of performers/participants and the corresponding dates at each event location. The AI agent then evaluates whether each identified event, defined by a specific participant, date, and event location combination, already exists in the database. As depicted at step 412, if the event is not already recorded in the database 406, the AI agent stores it as a new entry comprising the date, participant identifier, and event location identifier. In parallel, at step 414, the AI agent 404 checks whether the performer/participant is new to the system. If the performer/participant is not yet present in the database, a new performer/participant entry is created. This process ensures the event location calendar–participant database remains current and structured for downstream inferences about event attendance and user interest profiling.

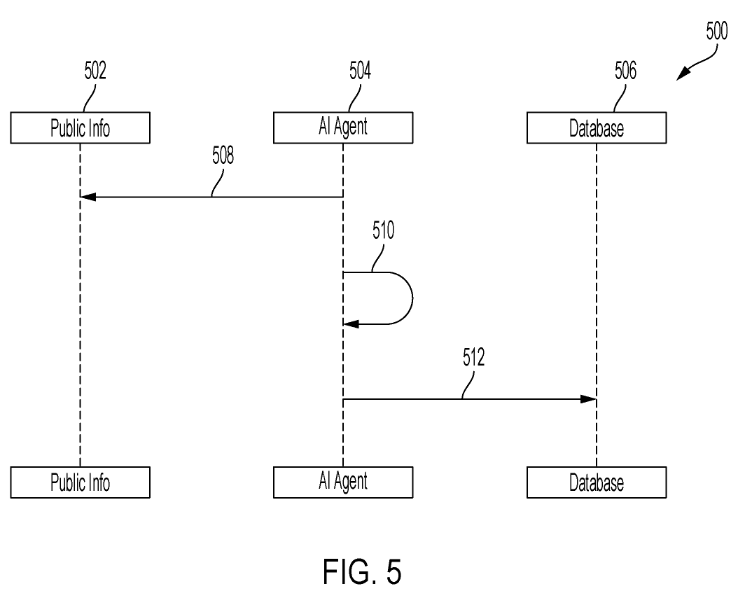

FIG. 5 illustrates a process 500 for constructing and maintaining a participant–sub-type database in accordance with at least one aspect of the present disclosure. This process is performed periodically for existing performers/participants or on an ad hoc basis when a new performer/participant is identified, with the goal of building a descriptive and indexable representation of each performer/participant.

The process 500 begins at step 508, in which the AI agent 504 searches publicly available sources (Public Info 502), including but not limited to biographical information, reviews, and online discussions, to collect data related to the artist. At step 510, from the retrieved content, the AI agent parses textual descriptions and extracts identifiable sub-type descriptors associated with the performer/participant, including but not limited to a genre of music or performance or sport type. This extraction is performed using natural language processing and LLM-based reasoning techniques applied to unstructured public content. At step 512, the AI agent then evaluates whether the extracted descriptors are already present in the database. If a new descriptor is identified, the AI agent stores the artist-descriptor pair in the database, ensuring the system maintains a current and detailed understanding of each performer/participant's sub-type affiliations.

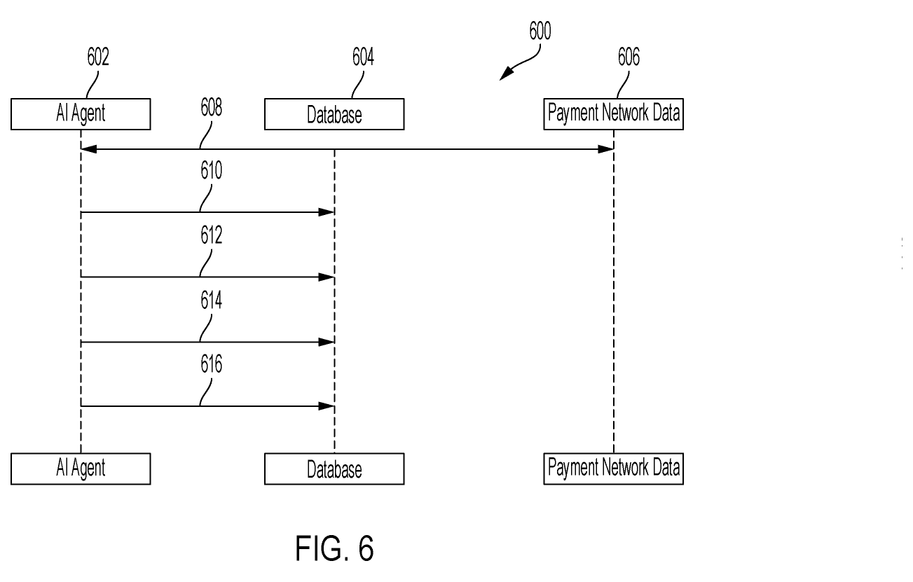

FIG. 6 illustrates a process 600 for constructing and maintaining a consumer preferences database in accordance with at least one aspect of the present disclosure. This process is periodically executed for each payment network cardholder to develop a profile of the cardholder’s attendance at live events, with a focus on identifying preferred performers/participants and event sub-types.

The process 600 begins at step 608, in which the AI agent retrieves transaction data corresponding to purchases made at event locations from the payment network data 606, filtering the data to include only those merchants previously indexed in the event database. At step 610, using the merchant identifier and transaction date from the filtered transaction records, the AI agent 602 queries the database 604 to identify the associated event and retrieve the corresponding artist or artists. At step 612, the AI agent 602 then queries the performer-sub-type database within the database 604 to obtain the sub-type descriptors linked to each identified artist, as established by process 500. At step 614, the AI agent generates and stores consumer-level preference signals, associating the cardholder with specific performers/participants and sub-type descriptors based on observed attendance. At step 616, the agent compiles this data into a summary table for each cardholder, aggregating event attendance over a defined period (e.g., the past X months) and quantifying the frequency of participant and sub-type-level interactions. This structured profile serves as a foundation for personalized content delivery, recommendations, and other downstream applications.

The flows described in FIGS. 3 - 6 form the foundation for an intelligent, adaptive system that operates within an AI/ML-driven payment network environment. The execution of these flows relies on one or more AI/ML computers configured to perform data retrieval, parsing, inference, and profile generation tasks at scale. These AI/ML computers may be part of a distributed AI/ML computer system embedded within the payment network infrastructure, capable of orchestrating agent operations, executing machine learning models, and interfacing with both proprietary transaction data and publicly available web content. Through this architecture, the system leverages computational intelligence to transform raw transactional signals into enriched consumer preference insights, supporting real-time personalization and downstream decision-making across the payment ecosystem.

In one embodiment, a method for generating consumer interest profiles based on event-related transactions comprises receiving transaction data identifying a third-party merchant and a timestamp associated with a purchase made by a user at an event. Determining the event location associated with the third-party merchant comprises executing a fuzzy-matching algorithm against the location-merchant mapping database, wherein the fuzzy-matching algorithm comprises address matching or name similarity scoring applied to merchant identifiers extracted from the transaction data and event location records maintained in the location-merchant mapping database. Identifying the event associated with the event location and timestamp comprises executing a temporally-constrained query against the event location calendar database to identify an event record corresponding to the event location and the timestamp of the transaction. The system retrieves event metadata associated with the identified event record, and generates and stores a consumer preference signal associating the user with the identified event record and the event metadata.

In some embodiments, the system queries an event-type database to identify an event-type associated with the event location and the timestamp. The event-type may be, but is not limited to one of: a musical event associated with a performing artist; a sporting event associated with one or more sports teams; a performance associated with a performing ensemble; a theatrical event; a vendor market; an amusement park or attraction; a public meeting; a professional conference; or an identifiable event associated with a recognized title. The event metadata comprises at least an event-type and one or more event descriptors. Querying the event-type database may comprise prompting a language model with an event location identifier and timestamp to generate a search query, executing the search query against publicly available sources, evaluating a relevance of retrieved results, and adaptively modifying the query based on result sparsity or excess until converging on a set of event descriptors for the event location and timestamp.

In some embodiments, the system comprises a language-based AI model operatively coupled to the payment network. The language-based AI model is configured to receive a query from the payment network comprising the event location identifier and the timestamp, execute the query against publicly available sources, evaluate a relevance of retrieved results, adaptively modify the query based on result sparsity or excess until converging on a set of event descriptors for the event location and timestamp, and return an event-type associated with the event location and the timestamp. The payment network is configured to generate and store the consumer preference signal associating the user with the event record, the event-type returned by the language-based AI model, and the event metadata and generate a personalized recommendation or offer for the event or a future event based on the consumer preference signal.

In embodiments where multiple events may be associated with an event location and timestamp, the system classifies the event into one of the event-types by applying a classification model to temporal proximity data, merchant category code data, and event-type database records associated with the event location and the timestamp. Where two or more candidate events are identified as plausible for the event location and timestamp, the system generates a ranked set of candidate events with associated confidence scores, enabling downstream modules to select the most probable event or to maintain multiple candidate associations weighted by their respective confidence scores.

In some embodiments, the event metadata for an event having two or more participants comprises the event-type, a first participant identifier, and at least a second participant identifier. The two or more participants may include but are not limited to acts, teams, speakers, or other event participants. The system stores a first event-type preference signal associating the user with the event-type, the first participant identifier, and at least the second participant identifier. Upon identifying at least a second event-type preference signal of the same event-type for the user, the system computes an intersection of participant identifiers across the at least first and second event-type preference signals to identify a candidate preferred participant identifier common to the first and the second event-type preference signals. Computing the intersection comprises identifying a first participant set comprising the first participant identifier and at least the second participant identifier of the event, identifying a second participant set comprising a third participant identifier and at least a fourth participant identifier of a second event for the same event-type, and determining whether a participant identifier appears in both the first participant set and the second participant set. If a common participant identifier is found, the system designates that participant identifier as the candidate preferred participant identifier. This intersection-based approach enables the system to infer a user's preferred participant from a minimum of two event observations without requiring explicit user declaration, by identifying which participant is common across multiple attended events of the same event-type.

An example of an event having two or more participants is a sporting event. For sporting events, the event metadata comprises a sport type, a league identifier, a home team identifier, and a visiting team identifier. The system stores a first sporting event preference signal associating the user with the sport type, the league identifier, the home team identifier, and the visiting team identifier. Upon identifying at least a second sporting event preference signal of the same sport type for the user, the system computes an intersection of team identifiers across the at least first and second sporting event preference signals to identify a candidate preferred team identifier common to the first and the second sporting event preference signals. Computing the intersection comprises identifying a first team set comprising the home team identifier and the visiting team identifier of the first sporting event, identifying a second team set comprising the home team identifier and the visiting team identifier of the second sporting event, and determining whether a single team identifier appears in both the first team set and the second team set. If so, the system designates that team identifier as the candidate preferred team identifier. This intersection-based set-matching algorithm enables team-level preference inference from a minimum of two event observations without requiring explicit user declaration.

The consumer preference signal may be pseudonymized and stored as a tokenized identifier associated with the user, ensuring that no personally identifiable information is retained in the preference profile. In some embodiments, the system generates a hierarchical tag taxonomy for the user based on the event metadata, wherein the hierarchical tag taxonomy encodes a plurality of tags organized in a multi-level hierarchy proceeding from a broad event category to one or more specific event descriptors, and wherein each tag in the hierarchical tag taxonomy is associated with a machine-learning-maintained confidence score. For musical events, the hierarchical tag taxonomy may proceed from a genre descriptor to the identified artist. Upon receipt of each new transaction corresponding to a new inferred event, the system updates the hierarchical tag taxonomy by increasing a confidence score for each tag in the hierarchical tag taxonomy that is reinforced by the new inferred event and decreasing a confidence score for each pre-existing tag in the hierarchical tag taxonomy that is not reinforced by the new inferred event. This iterative confidence-score updating ensures that the confidence associated with each preference tag is refined with each new event observation rather than being fixed at a single observation.

In some embodiments, the system enriches transaction data using adaptive agentic querying by prompting a language model with the event location and the timestamp to generate a search query, executing the search query to retrieve public event data, evaluating a relevance of results using threshold criteria, adaptively modifying the query based on result sparsity or excess, converging on a set of event descriptors for the event location and timestamp, and associating the event descriptors with a user transaction to update the consumer preference profile. The agentic querying may be performed using a pre-trained large language model with iterative refinement logic based on retrieved document relevance. The system may further generate a summary table for the user indicating a count of artists or genres attended over a time window, aggregating event attendance data into a consumer-specific record that reflects artist and genre engagement over time. Genre descriptors may include a music genre label parsed from public biographical data or reviews associated with the identified artist.

In another embodiment, a method for generating consumer interest profiles based on event-related transactions comprises receiving, by a payment network, transaction data identifying a third-party merchant and a timestamp associated with a purchase made by a user at an event of a known event-type. A language-based AI model associated with the payment network determines an event location associated with the third-party merchant based on a location-merchant mapping database. The language-based AI model associated with the payment network identifies the event and a participant associated with the event location and timestamp based on an event location calendar database. The language-based AI model associated with the payment network retrieves a sub-type descriptor associated with the participant from a participant-descriptor database. The payment network generates and stores a consumer preference signal associating the user with the identified participant and sub-type descriptor. The consumer preference signal may be pseudonymized and stored as a tokenized identifier.

In some embodiments, the language-based AI model associated with the payment network generates a summary table for the user indicating a count of participants or sub-types attended over a time window for the known event-type, aggregating event attendance data into a consumer-specific record that reflects participant and sub-type engagement over time. The sub-type descriptor may include a sub-type label parsed from public data or reviews of the participant, including but not limited to a music genre label parsed from public biographical data or reviews associated with the identified participant. The location-merchant mapping may comprise address matching or name similarity scoring applied by the language-based AI model associated with the payment network to merchant identifiers extracted from the transaction data and event location records maintained in the location-merchant mapping database.

In some embodiments, the language-based AI model associated with the payment network generates a hierarchical tag taxonomy for the user based on the identified participant and sub-type descriptor, wherein the hierarchical tag taxonomy encodes a plurality of tags organized in a multi-level hierarchy proceeding from a sub-type descriptor to the identified participant, and wherein each tag in the hierarchical tag taxonomy is associated with a machine-learning-maintained confidence score.

In practical deployment, the system operates as a continuously running background service within a payment network's cloud infrastructure. The system comprises a location-merchant indexing module configured to map merchants to event locations using fuzzy matching of transaction data, which executes on a scheduled basis (e.g., daily or weekly) to detect newly indexed event locations and update location-merchant associations. An event location calendar crawler is configured to retrieve event schedules and identify performing artists at each event location and date and executes periodically or on demand based on event location update schedules aligned with each event location's announcement cadence. An artist descriptor engine is configured to retrieve and store descriptors of artists based on public biographical and media content and executes on an artist-specific schedule (e.g., monthly for established artists, immediately upon first identification of a new artist). A transaction processing module is configured to infer events attended by users based on third-party merchant and timestamp data and executes in near-real-time as transactions are processed through the payment network, with event identification latency constrained by the freshness of the event location calendar and artist descriptor databases. A user profile module is configured to store inferred artist and genre interest signals for each user, and consumer preference signals are updated after transaction processing. A privacy control module is configured to enforce user consent before exposing preference signals to third parties, ensuring that no consumer preference data is shared with external entities unless the consumer has explicitly opted in through the consent and data token enrollment process. The entire pipeline is designed to operate within the latency and throughput constraints of a payment network's transaction processing infrastructure, ensuring that preference signal generation does not introduce material delay into the payment authorization or settlement workflow.

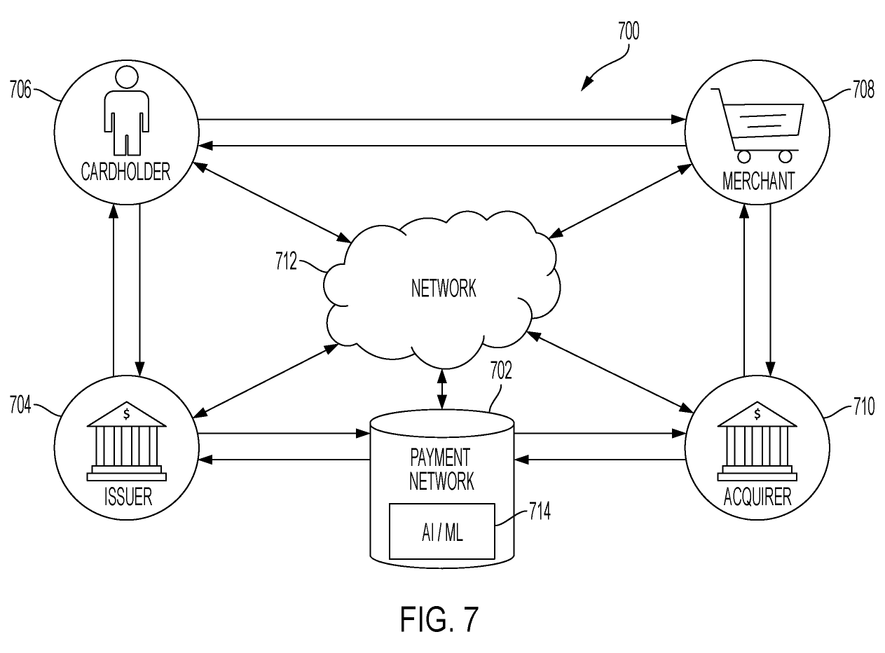

FIG. 7 illustrates a payment network system 700, according to various embodiments of the present disclosure. The payment network system facilitates payment transactions between a plurality of entities, including a payment network 702, an issuer 704, a cardholder 706, a merchant 708, and an acquirer 710. Each of these entities is communicatively coupled via a communication network 712, which may include one or more computer systems and network infrastructure (e.g., the Internet, cellular networks, and other wired or wireless communication paths).

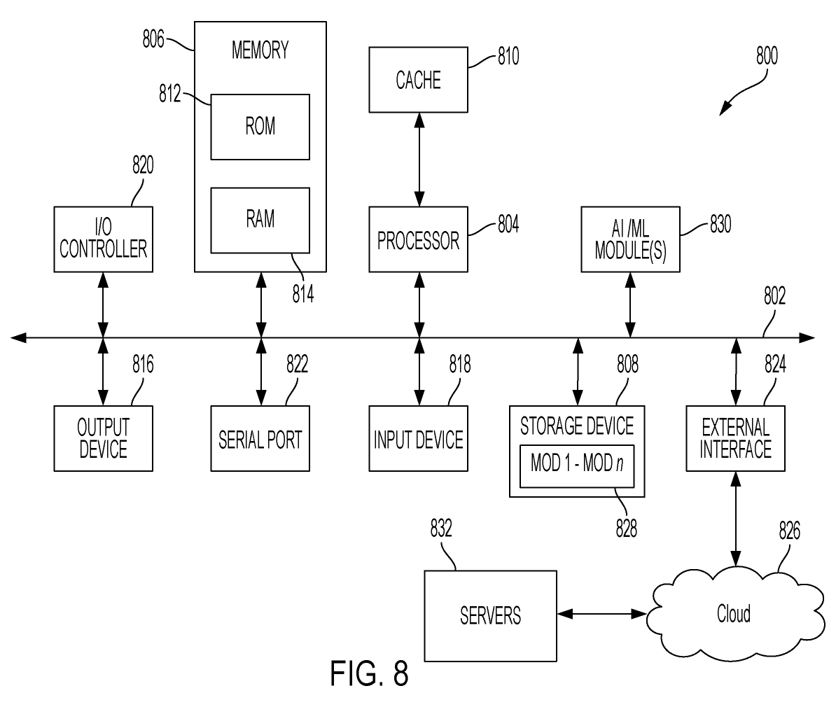

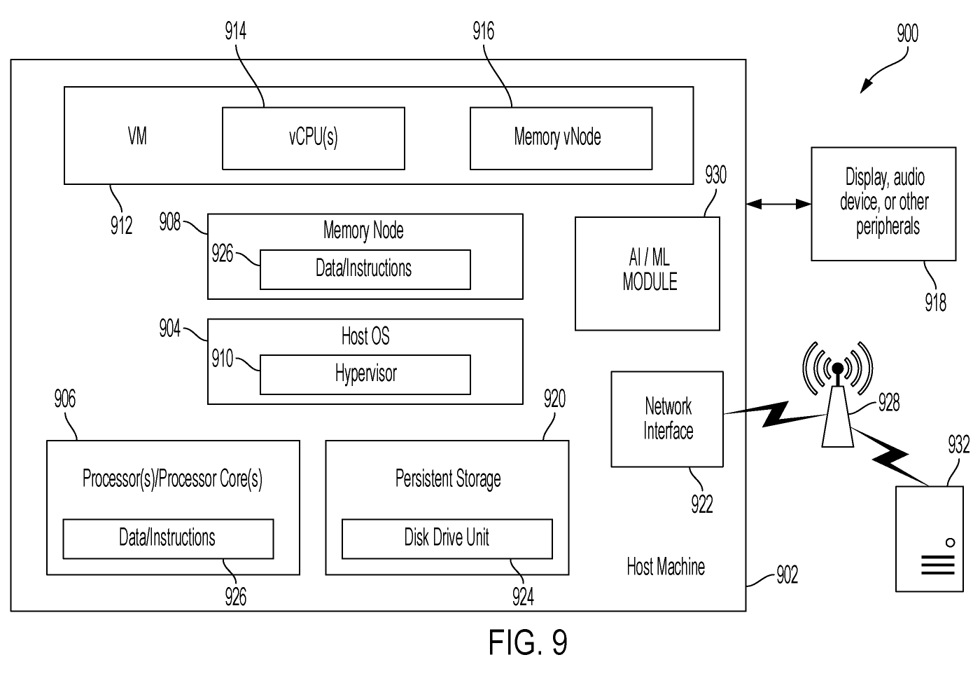

The payment network may include one or more server computers, processing subsystems, and network elements configured to support transaction processing, authorization, and settlement. The payment network is further configured to route authorization requests and responses between acquirers and issuers and to maintain operational control over clearing, fraud detection, and risk management workflows. In some embodiments, the payment network includes or is associated with a computer system as described in FIGS. 8 and 9 and may operate over a communication system.

The issuer may be a financial institution (e.g., a bank) that issues payment accounts to consumers. The issuer may be responsible for provisioning an account to a cardholder, which account may be associated with a Primary Account Number (PAN) or other identifier. The issuer is further responsible for performing account-level functions including, but not limited to, authorization of transactions, fraud assessment, and risk management. In certain implementations, the issuer also may act as the acquirer.

The account holder may access the payment network system using a client device or user device, such as a mobile phone, tablet, laptop, or smart card. The cardholder may initiate a payment transaction with a merchant using the account issued by the issuer. For example, the cardholder may present the account (or a tokenized version thereof) to the merchant using a near field communication (NFC) interface at a point-of-sale terminal. In other embodiments, the merchant may store the PAN or an associated token in a card-on-file system for use in recurring or future transactions.

Authentication of the account holder may be performed by the issuer using a variety of identity verification mechanisms. In some embodiments, the issuer may use a 3-D Secure Access Control Server (ACS), mobile banking verification, federated login systems, or other authentication mechanisms involving shared secrets, activation codes, or one-time passwords (OTPs). OTPs may be generated and delivered through out-of-band channels, such as secure mobile applications. In certain aspects, static passwords and enrollment-based verification may be disallowed to enhance security. Preferred OTP implementations may involve codes of 6 to 8 digits, generated using a consistent methodology and delivered securely to a registered device of the account holder.

The acquirer may be a financial institution or processing system associated with the merchant. The acquirer may be responsible for managing the merchant’s account and may provide services including, but not limited to, authorization request routing, transaction capture, clearing, settlement, and exception handling. In a transaction flow, the acquirer may receive a payment request from the merchant and forward an authorization request message to the issuer via the payment network. The response received from the issuer may be relayed back to the merchant by the acquirer.

The payment network is configured to handle routing of transaction messages between the acquirer and the issuer. Implementations include, without limitation, the payment network is responsible for forwarding authorization requests and responses, managing settlement procedures, and implementing transaction logging and fraud detection.

In certain embodiments, the payment network includes a generative AI and machine learning (ML) (collectively, AI/ML) module 714. This AI/ML module is configured to analyze transaction data processed by the payment network and to support the enrichment of transaction records with event-related context, including event location resolution, event identification, participant association, and consumer preference signal generation. The AI/ML module may generate confidence scores associated with inferred event attendance and may provide adaptive querying capabilities for retrieving and evaluating publicly available event metadata based on contextual transaction attributes, such as merchant identifiers, timestamps, merchant category codes, and geolocation data.

The AI/ML module may be implemented as a cloud-based platform within the payment network and may utilize pseudonymization and consent-driven data token mechanisms to maintain data privacy while enabling enrichment of transaction data across the payment network infrastructure. The system may be further configured to continuously train on historical transaction and event data to enhance event inference accuracy, confidence scoring, and consumer preference signal generation.

A system of one or more computers can be configured to perform particular operations or actions associated with the agentic commerce and transaction enrichment methods described herein by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions. Other embodiments include corresponding computer systems, apparatus, and computer programs recorded on one or more computer storage devices, each configured to perform the actions of the methods.

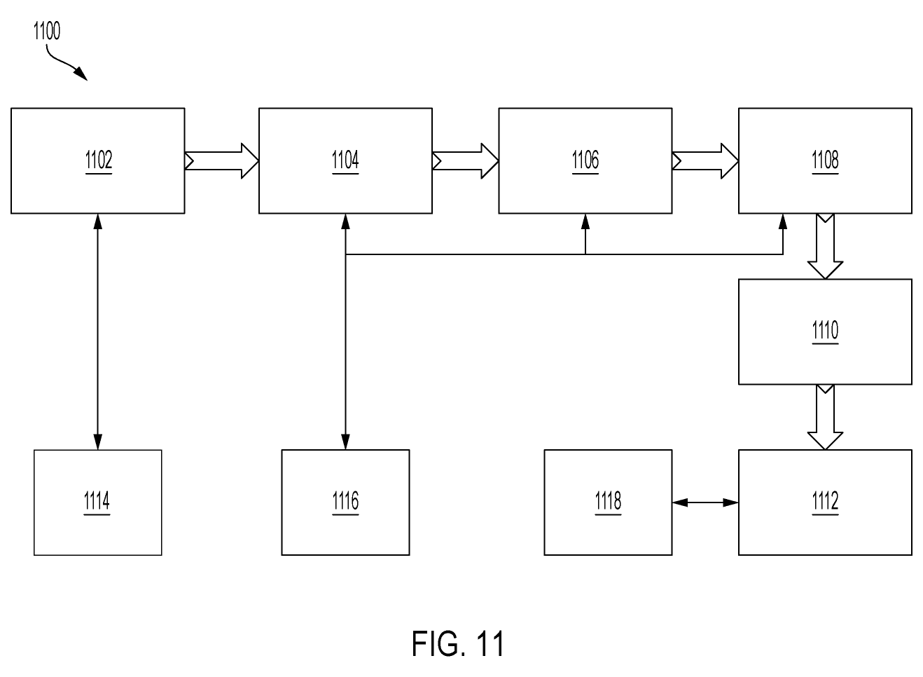

The multi-module data-enrichment pipeline described above and illustrated in FIG. 11, comprising the transaction processing module 1102, the location-merchant indexing module 1104, the event calendar crawler module 1106, the artist/participant descriptor engine 1108, the preference signal generation module 1110, the LLM-based adaptive query engine 1116, and the privacy control module 1118, is implemented on one or more computing apparatus configured with the hardware, software, and artificial intelligence components necessary to execute the methods described herein. FIG. 8 illustrates an example computing apparatus 800 suitable for implementing any one or more of these modules. In particular, the processor 804 executes the fuzzy-matching algorithm applied against the location-merchant mapping database to resolve third-party merchant identifiers to event location identifiers; the temporally-constrained queries directed against the event-location calendar database to identify event records; the classification model applied to temporal-proximity data, merchant category code data, and event-type database records; and the intersection-based set-matching algorithm that computes the intersection of participant identifier sets across event-type preference signals to identify candidate preferred participant identifiers. The storage device 808 serves as a persistent repository for the location-merchant mapping database, the event-location calendar database, the participant-descriptor database, and the consumer preference profile store 1112 in which pseudonymized consumer preference signals are stored as tokenized identifiers. The software modules 828 stored in the storage device 808 and executed by the processor 804 correspond to the discrete functional modules of the data-enrichment pipeline, including, without limitation, the transaction processing module 1102, the location-merchant indexing module 1104, the event calendar crawler module 1106, the artist/participant descriptor engine 1108, the preference signal generation module 1110, and the privacy control module 1118. The AI and ML modules 830 implement the language-based artificial intelligence model and the LLM-based adaptive query engine 1116, which generate, execute, and iteratively refine search queries against publicly available sources to retrieve event descriptors, classify event-types, compute confidence scores for inferred event attendance, and maintain the confidence-weighted hierarchical tag taxonomy associated with each user's consumer preference profile.

FIG. 8 illustrates a computer apparatus 800 configured with various interconnected data processing subsystems in accordance with at least one aspect of the present disclosure. These subsystems are interconnected via a system bus 802, which enables coordinated communication between components involved in executing the event inference and consumer preference signal generation methods described herein. A processor 804 (e.g., central processing unit (CPU), control circuit) serves as the computational core of the apparatus 800 and interfaces with system memory 806 and a storage device 808 to execute the software modules 828 that implement the functional stages of the data-enrichment pipeline. The processor 804 may include integrated or closely coupled high-speed cache memory 810, which supports the low-latency execution of computationally intensive operations including fuzzy-matching of third-party merchant identifiers against the location-merchant mapping database, temporally-constrained lookups against the event-location calendar database, and iterative confidence-score computation applied to inferred event attendance records and the hierarchical tag taxonomy.

The system memory 806 may include different types of memory with varying performance characteristics, including read-only memory (ROM) 812 and random-access memory (RAM) 814. The RAM 814 may store in-flight transaction data received by the payment network, intermediate query results generated by the LLM-based adaptive query engine 1116 during iterative search refinement against publicly available event sources, and working copies of the hierarchical tag taxonomy during confidence-score updating operations. The ROM 812 may store firmware instructions and bootstrap logic necessary for low-level initialization of the apparatus 800.

Input and output devices interface with the apparatus 800 through dedicated channels. An output device 816, (such as a monitor or printer) such as a display or logging interface, and an input device 818 (such as a keyboard or mouse) are coupled to the apparatus 800 through an input/output (I/O) controller 820, supporting administrative interaction with the data-enrichment pipeline. Additional peripherals may connect via a serial port 822 or through an external interface 824. The external interface 824 facilitates connectivity to external systems and cloud-hosted services 826, enabling the apparatus 800 to access the publicly available event calendars, biographical data sources, and ticketing databases queried by the event calendar crawler module 1106 and the artist/participant descriptor engine 1108, as well as to communicate with distributed instances of the language-based artificial intelligence model and the payment network transaction data store 1114.

Software modules 828 stored in the storage device 808 are executed by the processor 804 to implement the discrete functional stages of the data-enrichment pipeline. These software modules include, without limitation: the transaction processing module 1102, which receives and filters transaction data comprising third-party merchant identifiers and timestamps from the payment network; the location-merchant indexing module 1104, which applies the fuzzy-matching algorithm to resolve merchant identifiers to event location identifiers; the event calendar crawler module 1106, which retrieves and maintains event schedules for known event locations and extracts participant identifiers and event dates therefrom; the artist/participant descriptor engine 1108, which retrieves sub-type descriptors from publicly available biographical content and stores them in the participant-descriptor database; the preference signal generation module 1110, which generates confidence-weighted, hierarchically-tagged consumer preference signals and stores them as pseudonymized tokenized identifiers in the consumer preference profile store 1112; and the privacy control module 1118, which enforces consent-based access controls over the exposure of consumer preference signals to third-party agent providers. The processor 804 may be a general-purpose processor, a specialized processor with embedded machine learning inference logic, or a multi-core processor configured to support parallel execution of pipeline stages.

To support real-time transaction processing and adaptive event inference, the apparatus 800 may incorporate multimodal input and output capabilities relevant to the payment network's operational context. The input device 818 may receive transaction data streams from payment network interfaces, while the external interface 824 may manage both inbound queries from AI agent providers presenting data tokens and outbound transmissions of consumer preference signals to authorized agent providers. This bidirectional external interface supports the consent-driven data token mechanism described herein, through which an agent provider presents a data token, issued by the payment network upon consumer enrollment, to authorize retrieval of the consumer preference signals stored in the consumer preference profile store 1112.

The storage device 808 may be implemented using any suitable non-volatile computer-readable medium, including flash memory, solid-state drives, magnetic storage, optical disks, or hybrids thereof, and serves as the persistent repository for the location-merchant mapping database, the event-location calendar database, the participant-descriptor database, and the consumer preference profile store 1112. In some embodiments, pipeline components responsible for time-sensitive operations, such as real-time transaction ingestion by the transaction processing module 1102 and near-real-time event identification by the location-merchant indexing module 1104, may be implemented as combined hardware-software modules that exploit the processor 804, the system bus 802, and specialized peripheral components to satisfy the latency and throughput constraints of the payment network's transaction processing infrastructure, ensuring that preference signal generation does not introduce material delay into the payment authorization or settlement workflow.

Embedded within the apparatus 800 are artificial intelligence and machine learning modules 830, which implement the language-based artificial intelligence model and the LLM-based adaptive query engine 1116. These modules execute the core intelligence functions of the data-enrichment pipeline, including: generating and adaptively refining search queries directed against publicly available sources to retrieve event metadata associated with identified event locations and timestamps; classifying inferred events into event-types by applying a classification model to temporal-proximity data, merchant category code data, and event-type database records; generating ranked sets of candidate events with associated confidence scores where two or more events are determined to be plausible for a given event location and timestamp; maintaining and updating the confidence-weighted hierarchical tag taxonomy for each user by increasing confidence scores for tags reinforced by new inferred events and decreasing confidence scores for tags not so reinforced; and computing the intersection of participant identifier sets across stored event-type preference signals to identify candidate preferred participant identifiers. High-performance processing units, including Tensor Processing Units (TPUs), Graphical Processing Units (GPUs), and Central Processing Units (CPUs), support the continuous training and refinement of these AI and ML models.

The AI-driven algorithms of the AI and ML modules 830 analyze real-time transaction data and contextual inputs to identify event-related patterns, correlate third-party merchant identifiers with event location identifiers via the fuzzy-matching algorithm, and resolve transaction timestamps against the event-location calendar database. Through this process, the apparatus 800 dynamically enriches transaction records with event metadata, including event-type, participant identifiers, and sub-type descriptors, and refines consumer preference signals through iterative confidence-score updating applied to the hierarchical tag taxonomy. The models supporting these capabilities are deployed across distributed cloud servers 832, which enable high-throughput, parallel processing of the transaction volumes handled by the payment network and support scalable model inference across the full multi-module data-enrichment pipeline.

While FIG. 8 depicts an example computing apparatus 800 suitable for implementing one or more individual modules of the data-enrichment pipeline in a self-contained configuration, the systems and methods of the present disclosure are designed to operate across distributed, networked computing environments in which the payment network server infrastructure, the language-based artificial intelligence model, and the underlying databases, including the location-merchant mapping database, the event-location calendar database, the participant-descriptor database, and the consumer preference profile store 1112, are deployed across multiple interconnected machines. In such deployments, the transaction processing module 1102, the location-merchant indexing module 1104, the event calendar crawler module 1106, the artist/participant descriptor engine 1108, the preference signal generation module 1110, the LLM-based adaptive query engine 1116, and the privacy control module 1118 may each be hosted on separate physical or virtual computing nodes, communicating over the payment network's communication infrastructure to collectively execute the multi-stage event inference and consumer preference signal generation workflow. FIG. 9 illustrates an example computer system 900 representative of the networked computing environment within which such distributed deployments may be realized, depicting the hardware and software components of a host machine 902 suitable for hosting any one or more of the aforementioned pipeline modules.

FIG. 9 illustrates a diagrammatic representation of an example computer system 900, including a host machine 902 configured to execute one or more sets of instructions implementing any one or more of the methodologies described herein — including the fuzzy-matching-based location-merchant resolution, the temporally-constrained event identification, the LLM-driven adaptive querying of publicly available event sources, the hierarchical tag taxonomy generation and confidence-score updating, and the pseudonymization and tokenized storage of consumer preference signals. The host machine 902 may operate as a standalone system, for example, as a self-contained payment network server executing the full data-enrichment pipeline, or in a networked configuration with other machines, such as when the payment network and the language-based artificial intelligence model are hosted on separate nodes communicating over shared network infrastructure, with the payment network transmitting event location identifiers and timestamps to the language-based artificial intelligence model and receiving event-type classifications and event descriptors in return.

The computer system 900 includes a host operating system 904 running on one or more processors 906, which may include central processing units (CPUs), graphical processing units (GPUs), or other specialized processors appropriate for the computational workloads of the data-enrichment pipeline, including parallel execution of the LLM-based adaptive query engine 1116, batch processing of fuzzy-matching operations by the location-merchant indexing module 1104, and inference over machine learning models that compute confidence scores and update the hierarchical tag taxonomy. These processors 906 interface with one or more memory nodes 908 for storing executable instructions corresponding to the software modules of the pipeline and runtime data including in-flight transaction records, intermediate query results, and working copies of the consumer preference profile store 1112. In some embodiments, the host operating system 904 may include a hypervisor 910 that manages communication with one or more virtual machines 912. Each virtual machine 912 may operate with a virtual CPU (vCPU) 914 and utilize virtual memory nodes (vNodes) 916 pinned to corresponding physical memory to optimize data access efficiency for latency-sensitive pipeline operations such as real-time transaction processing by the transaction processing module 1102 and near-real-time event inference by the location-merchant indexing module 1104.

System components communicate via one or more buses or interconnect mechanisms supporting the high-throughput data exchange requirements of the data-enrichment pipeline. Peripheral devices 918 may support administrative interaction with the host machine 902 and may include displays, keyboards, or voice recognition units. Persistent storage 920 may be implemented using hard disk drives (HDDs), solid-state drives (SSDs), or other non-volatile memory, and serves as the storage medium for the location-merchant mapping database, the event-location calendar database, the participant-descriptor database, and the consumer preference profile store 1112. A network interface device 922 enables the host machine 902 to communicate with the external systems necessary for operation of the data-enrichment pipeline, including the publicly available event calendar sources queried by the event calendar crawler module 1106, the biographical and review sources queried by the artist/participant descriptor engine 1108, and the payment network infrastructure components with which the host machine 902 exchanges transaction data and consumer preference signals. In some implementations, a data encryption module may be integrated to protect consumer preference signals and tokenized identifiers during storage and transmission, consistent with the privacy-preserving design principles of the consent-driven data token mechanism.

Instructions and data structures implementing the disclosed methodologies, including the software modules of the data-enrichment pipeline and the trained parameters of the AI and ML models used for event classification, confidence scoring, and hierarchical tag taxonomy maintenance, may be stored in a disk drive unit 924, which serves as a machine-readable storage medium. Stored data and instructions 926, including the fuzzy-matching logic of the location-merchant indexing module 1104, the temporally-constrained query logic of the transaction processing module 1102, and the confidence-weighted hierarchical tag taxonomy records of the consumer preference profile store 1112, may be accessed in whole or in part by the memory nodes 908 or the processors 906 during execution. These instructions may also be transmitted over a network 928 using standard protocols to support distributed deployments of the data-enrichment pipeline across multiple instances of the host machine 902.

The machine-readable media utilized by the computer system 900 to store and transmit the instructions and data structures of the data-enrichment pipeline may take many forms, including solid-state memory, magnetic or optical media, and transmission media. These media may encode the executable logic of the transaction processing module 1102, the location-merchant indexing module 1104, the event calendar crawler module 1106, the artist/participant descriptor engine 1108, the preference signal generation module 1110, the LLM-based adaptive query engine 1116, and the privacy control module 1118, as well as the trained model parameters and database records on which these modules operate, including the location-merchant mapping database, the event-location calendar database, the participant-descriptor database, and the consumer preference profile store 1112.

Artificial intelligence and machine learning modules 930 may be integrated into the host machine 902 to implement the language-based artificial intelligence model and the LLM-based adaptive query engine 1116 described herein. These modules leverage the combined computational capabilities of Tensor Processing Units (TPUs), GPUs, and CPUs to support the continuous training and refinement of the machine learning models used for event-type classification, confidence-score computation, hierarchical tag taxonomy updating, and intersection-based preferred participant inference. These models may be deployed across distributed cloud servers 932, enabling scalable and parallelized processing of the transaction volumes and public event data ingestion workloads associated with the payment network's data-enrichment pipeline. Through this distributed architecture, the AI and ML modules 930 maintain the freshness of the location-merchant mapping database, the event-location calendar database, and the consumer preference profile store 1112 across the full cardholder population served by the payment network.

Through real-time data ingestion and analysis, the AI and ML algorithms of the modules 930 enable the computer system 900 to infer event attendance from transaction data processed by the payment network, adapt search strategies for event metadata retrieval through the iterative query refinement logic of the LLM-based adaptive query engine 1116, and optimize consumer preference signal generation by updating the confidence-weighted hierarchical tag taxonomy with each new inferred event. The computer system 900 may further include an enrollment module configured to capture consumer consent and issue a data token through the payment network, wherein the data token serves as a unique reference identifier authorizing an agent provider to request consumer preference signals from the payment network. A token module associates a consumer's payment credential with a payment token and provisions the payment token to the agent provider. A communication module transmits the data token to the agent provider, enabling the agent provider to present the data token to the payment network when requesting the consumer preference signals stored in the consumer preference profile store 1112 and pseudonymized as tokenized identifiers associated with the user.

This architecture supports secure agent-mediated transactions and enables AI agent providers, upon presentation of a valid data token, to access enriched consumer preference signals, including event-type associations, participant identifiers, sub-type descriptors, and confidence-weighted hierarchical tag taxonomy records, to drive downstream personalization, targeted offer delivery, and audience segmentation based on demonstrated event attendance patterns. The foregoing functionality may be implemented via hardware, software, or a hybrid configuration, and corresponding systems, devices, and computer program products implementing the data-enrichment pipeline described herein are within the scope of the appended claims.

The computer system 900 may operate across a range of network types including local area networks (LANs), wide area networks (WANs), virtual private networks (VPNs), and wireless networks (e.g., GSM, LTE, Wi-Fi), supporting distributed deployment of the data-enrichment pipeline modules across the payment network's cloud infrastructure and enabling high-throughput exchange of transaction data, publicly available event metadata, and consumer preference signals between pipeline components. Interface compatibility may extend to USB, Ethernet, and other standard communication protocols supporting the operational requirements of the payment network's processing infrastructure.

In cloud-based environments, groups of networked host machines 902 collaborate to deliver the compute and storage services required by the data-enrichment pipeline, including the LLM-based adaptive query engine 1116 operations that generate and iteratively refine search queries against publicly available sources, the scheduled batch processing operations of the location-merchant indexing module 1104 and event calendar crawler module 1106, and the near-real-time preference signal generation operations of the preference signal generation module 1110. These machines dynamically allocate resources across workloads to maintain the data freshness and processing throughput necessary for accurate, scalable, and privacy-preserving inference of consumer event attendance and interest profiles across the full cardholder population of the payment network.

Any suitable computing hardware capable of executing the disclosed methodologies may be employed. The term “computer-readable medium” includes non-volatile storage (e.g., magnetic or optical disks), volatile memory (e.g., dynamic RAM), and transmission media (e.g., coaxial cables, infrared signals). These media may be used individually or in combination to deliver instruction sequences to a CPU.

Instructions may be fetched from system RAM or disk and executed by the processor. Code may be written in languages including C, C++, Java, Python, Go, assembly, or others, and may run locally or remotely in a distributed configuration. The system is compatible with a wide range of operating systems and network architectures.

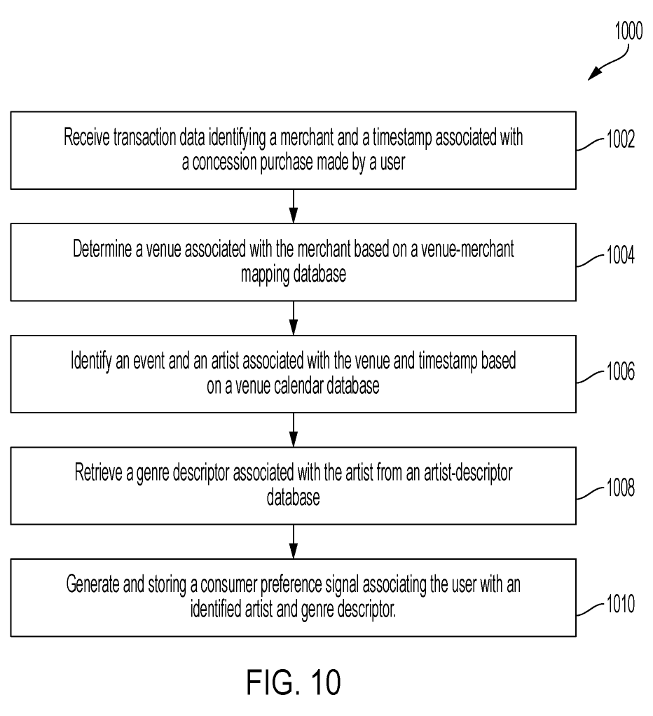

FIG. 10 illustrates a logic flow diagram of a method 1000 for generating consumer interest profiles based on event-related transactions, in accordance with at least one aspect of the present disclosure. According to the method, the system receives 1002 transaction data that identifies a third-party merchant and includes a timestamp corresponding to a purchase made by a user at an event. Using a location–merchant mapping database, the system determines 1004 the event location associated with the identified merchant. Once the event location and timestamp are established, the system accesses 1006 an event location calendar database to identify the specific event occurring at that event location during the transaction time, as well as the performing artist associated with that event. The system then retrieves 1008 one or more genre descriptors linked to the identified artist from an artist–descriptor database. Based on this information, the system generates 1010 a consumer preference signal that associates the user with the identified artist and genre descriptor, and stores the signal for use in constructing or updating the user’s interest profile.

FIG. 11 illustrates a multi-module data-enrichment pipeline architecture 1100 operating within a payment network infrastructure, in accordance with at least one aspect of the present disclosure. The pipeline comprises a transaction processing module 1102 configured to receive and filter transaction data from the payment network transaction data store 1114; a location-merchant indexing module 1104 configured to map merchants to event locations using fuzzy matching; an event calendar crawler module 1106 configured to retrieve and maintain event schedules for known event locations; an artist/participant descriptor engine 1108 configured to retrieve and store sub-type descriptors for identified participants; a preference signal generation module 1110 configured to generate confidence-weighted, hierarchically-tagged consumer preference signals and store them in the consumer preference profile store 1112; a privacy control module 1118 configured to enforce user consent before exposing preference signals to third parties; and an LLM-based adaptive query engine 1116 operatively coupled to modules 1104, 1106, and 1108 to generate, execute, and adaptively refine search queries against publicly available sources. Data flows from the transaction processing module 1102 through the location-merchant indexing module 1104, the event calendar crawler module 1106, and the artist/participant descriptor engine 1108 to the preference signal generation module 1110, which outputs consumer preference signals to the consumer preference profile store 1112 subject to privacy controls enforced by module 1118.

The present disclosure relates generally to consumer interest profiling systems and methods, and more particularly to systems and methods for inferring events attended by a user from payment transaction data received by a payment network, identifying event metadata associated with inferred events through the operative coupling of a language-based artificial intelligence model to the payment network, and generating and storing consumer preference signals that associate the user with inferred event records, event-types, participant identifiers, and sub-type descriptors derived therefrom. The consumer preference signals are organized into a dynamically updated hierarchical tag taxonomy maintained with machine-learning-derived confidence scores and stored in pseudonymized form as tokenized identifiers associated with the user. The consumer preference signals are used to generate a personalized recommendation or offer for the event or a future event.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for generating consumer interest profiles based on event-related transactions. The method also includes receiving, by a payment network, transaction data identifying a third-party merchant and a timestamp associated with a purchase made by a user at an event. The method also includes determining, by the payment network, an event location associated with the third-party merchant by executing a fuzzy-matching algorithm against a location-merchant mapping database; identifying, by the payment network, the event associated with the event location and timestamp by executing a temporally-constrained query against an event-location calendar database to identify an event record. The method also includes retrieving, by the payment network, event metadata associated with the event record. The method also includes generating and storing, by the payment network, a consumer preference signal associating the user with the event record and the event metadata, and generating, by the payment network, a personalized recommendation or offer for the event or a future event based on the consumer preference signal. Other embodiments of this aspect include corresponding computer systems, apparatus, and computer programs recorded on one or more computer storage devices, each configured to perform the actions of the methods.

Implementations may include one or more of the following features. The method may include querying, by a language-based AI model operatively coupled to the payment network, an event-type database to identify an event-type associated with the event location and the timestamp; where the event metadata may include at least an event-type and one or more event descriptors. Querying the event-type database may include: prompting, by the payment network, the language-based AI model with a location identifier and timestamp to generate a search query; executing, by the language-based AI model, the search query against publicly available sources; evaluating, by the language-based AI model, a relevance of retrieved results; and adaptively modifying, by the language-based AI model, the search query based on result sparsity or excess until converging on a set of event descriptors for the event location and timestamp. The method may include: classifying, by the language-based AI model, the event into an event-type by applying a classification model to temporal-proximity data, merchant category code data, and event-type database records associated with the event location and the timestamp; and upon identifying two or more candidate events as plausible for the event location and timestamp, generating a ranked set of candidate events with associated confidence scores. The event metadata for an event with two or more participants may include the event-type, a first participant identifier and at least a second participant identifier; storing, by the language-based AI model, a first event-type preference signal associating the user with the event-type, the first participant identifier, and at least the second participant identifier; and upon identifying at least a second event-type preference signal of a same event-type for the user, computing, by the language-based AI model, an intersection of participant identifiers across the at least first and second event-type preference signals to identify a candidate preferred participant identifier common to the first and the second event-type preference signals. Computing the intersection may include: identifying, by the language-based AI model, a first participant set may include the first participant identifier and at least the second participant identifier of the event; identifying, by the language-based AI model, a second participant set may include a third participant identifier and at least a fourth participant identifier of a second event for a same event-type; and determining, by the language-based AI model, whether a participant identifier appears in both the first participant set and the second participant set, and if so, designating that participant identifier as the candidate preferred participant identifier. The hierarchical tag taxonomy encodes a plurality of tags organized in a multi-level hierarchy proceeding from a broad event category to one or more specific event descriptors, and where each tag in the hierarchical tag taxonomy is associated with a machine-learning-maintained confidence score. The method may include: upon receipt of each new transaction corresponding to a new inferred event, updating, by the language-based AI model, the hierarchical tag taxonomy by: increasing a confidence score for each tag in the hierarchical tag taxonomy that is reinforced by the new inferred event; and decreasing a confidence score for each pre-existing tag in the hierarchical tag taxonomy that is not reinforced by the new inferred event. The method may include pseudonymizing, by the payment network, the consumer preference signal and storing the consumer preference signal as a tokenized identifier associated with the user. The method may include: prompting, by the payment network, a language-based AI model with the event location and the timestamp to generate a search query; executing, by the language-based AI model, the search query to retrieve public event data; evaluating, by the language-based AI model, a relevance of results using threshold criteria; adaptively modifying, by the language-based AI model, the search query based on result sparsity or excess; converging, by the language-based AI model, on a set of event descriptors for the event location and timestamp; and associating, by the language-based AI model, the set of event descriptors with a user transaction to update the consumer preference signal. Implementations of the described techniques may include hardware, a method or process, or computer software on a computer-accessible medium.

One general aspect includes a system for generating consumer interest profiles based on event-related transactions. The system includes a payment network configured to: receive transaction data identifying a third-party merchant and a timestamp associated with a purchase made by a user at an event; determine an event location associated with the third-party merchant by executing a fuzzy-matching algorithm against a location-merchant mapping database; identify the event associated with the event location and timestamp by executing a temporally-constrained query against an event location calendar database to identify an event record; retrieve event metadata associated with the event record; transmit a query to a language-based artificial intelligence (AI) model to identify an event-type associated with the event location and the timestamp; generate and store a consumer preference signal associating the user with the event record, event-type, and the event metadata; and generate a personalized recommendation or offer for the event or a future event based on the consumer preference signal. The system also includes a language-based AI model operatively coupled to the payment network, the language-based AI model configured to: receive the query from the payment network, execute the query against publicly available sources, evaluate a relevance of retrieved results, adaptively modify the query based on result sparsity or excess until converging on a set of event descriptors for the event location and timestamp, and return an event-type associated with the event location and the timestamp. Other embodiments of this aspect include corresponding computer systems, apparatus, and computer programs recorded on one or more computer storage devices, each configured to perform the actions of the methods.

Implementations may include one or more of the following features. The system where the language-based AI model is further configured to: generate a hierarchical tag taxonomy for the user based on the event metadata, where the hierarchical tag taxonomy encodes a plurality of tags organized in a multi-level hierarchy proceeding from a broad event category to one or more specific event descriptors, and where each tag in the hierarchical tag taxonomy is associated with a machine-learning-maintained confidence score; upon receipt of each new transaction corresponding to a new inferred event, update the hierarchical tag taxonomy by: increasing a confidence score for each tag in the hierarchical tag taxonomy that is reinforced by the new inferred event; and decreasing a confidence score for each pre-existing tag in the hierarchical tag taxonomy that is not reinforced by the new inferred event. The payment network is further configured to: pseudonymize the consumer preference signal and store the consumer preference signal as a tokenized identifier. Implementations of the described techniques may include hardware, a method or process, or computer software on a computer-accessible medium.

One general aspect includes a method for generating consumer interest profiles based on event-related transactions. The method also includes receiving, by a payment network, transaction data identifying a third-party merchant and a timestamp associated with a purchase made by a user at an event of a known event-type. The method also includes determining, by a language-based artificial intelligence (AI) model associated with the payment network, an event location associated with the third-party merchant based on a location-merchant mapping database; identifying, by the language-based AI model associated with the payment network, the event and a participant associated with the event location and timestamp based on an event location calendar database. The method also includes retrieving, by the language-based AI model associated with the payment network, a sub-type descriptor associated with the participant from a participant-descriptor database. The method also includes generating and storing, by the payment network, a consumer preference signal associating the user with an identified participant and sub-type descriptor and generating, by the payment network, a personalized recommendation or offer for the event or a future event based on the consumer preference signal. Other embodiments of this aspect include corresponding computer systems, apparatus, and computer programs recorded on one or more computer storage devices, each configured to perform the actions of the methods.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random-access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or sets of instructions and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. The term “configured to” can generally encompass active-state components and/or inactive-state components and/or standby-state components, unless context requires otherwise.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted being prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for generating consumer interest profiles based on event-related transactions, the method comprising:
receiving, by a payment network, transaction data identifying a third-party merchant and a timestamp associated with a purchase made by a user at an event;
determining, by the payment network, an event location associated with the third-party merchant by executing a fuzzy-matching algorithm against a location-merchant mapping database;
identifying, by the payment network, the event associated with the event location and timestamp by executing a temporally-constrained query against an event-location calendar database to identify an event record;
retrieving, by the payment network, event metadata associated with the event record;
generating and storing, by the payment network, a consumer preference signal associating the user with the event record and the event metadata; and
generating, by the payment network, a personalized recommendation or offer for the event or a future event based on the consumer preference signal.

2. The method of claim 1, comprising:
querying, by a language-based artificial intelligence (AI) model operatively coupled to the payment network, an event-type database to identify an event-type associated with the event location and the timestamp;
wherein the event metadata comprises at least an event-type and one or more event descriptors.

3. The method of claim 2, wherein querying the event-type database comprises:
prompting, by the payment network, the language-based AI model with a location identifier and timestamp to generate a search query;
executing, by the language-based AI model, the search query against publicly available sources;
evaluating, by the language-based AI model, a relevance of retrieved results; and
adaptively modifying, by the language-based AI model, the search query based on result sparsity or excess until converging on a set of event descriptors for the event location and timestamp.

4. The method of claim 2, comprising:
classifying, by the language-based AI model, the event into an event-type by applying a classification model to temporal-proximity data, merchant category code data, and event-type database records associated with the event location and the timestamp; and
upon identifying two or more candidate events as plausible for the event location and timestamp, generating a ranked set of candidate events with associated confidence scores.

5. The method of claim 2, wherein the event metadata for an event with two or more participants comprises the event-type, a first participant identifier and at least a second participant identifier;
storing, by the language-based AI model, a first event-type preference signal associating the user with the event-type, the first participant identifier, and at least the second participant identifier; and
upon identifying at least a second event-type preference signal of a same event-type for the user, computing, by the language-based AI model, an intersection of participant identifiers across the at least first and second event-type preference signals to identify a candidate preferred participant identifier common to the first and the second event-type preference signals.

6. The method of claim 5, wherein computing the intersection comprises:
identifying, by the language-based AI model, a first participant set comprising the first participant identifier and at least the second participant identifier of the event;
identifying, by the language-based AI model, a second participant set comprising a third participant identifier and at least a fourth participant identifier of a second event for a same event-type; and
determining, by the language-based AI model, whether a participant identifier appears in both the first participant set and the second participant set, and if so, designating that participant identifier as the candidate preferred participant identifier.

7. The method of claim 2, further comprising generating, by the language-based AI model, a hierarchical tag taxonomy for the user based on the event metadata, wherein the hierarchical tag taxonomy encodes a plurality of tags organized in a multi-level hierarchy proceeding from a broad event category to one or more specific event descriptors, and wherein each tag in the hierarchical tag taxonomy is associated with a machine-learning-maintained confidence score.

8. The method of claim 7, further comprising:
upon receipt of each new transaction corresponding to a new inferred event, updating, by the language-based AI model, the hierarchical tag taxonomy by:
increasing a confidence score for each tag in the hierarchical tag taxonomy that is reinforced by the new inferred event; and
decreasing a confidence score for each pre-existing tag in the hierarchical tag taxonomy that is not reinforced by the new inferred event.

9. The method of claim 1, further comprising pseudonymizing, by the payment network, the consumer preference signal and storing the consumer preference signal as a tokenized identifier associated with the user.

10. The method of claim 1, further comprising:
prompting, by the payment network, a language-based AI model with the event location and the timestamp to generate a search query;
executing, by the language-based AI model, the search query to retrieve public event data;
evaluating, by the language-based AI model, a relevance of results using threshold criteria;
adaptively modifying, by the language-based AI model, the search query based on result sparsity or excess;
converging, by the language-based AI model, on a set of event descriptors for the event location and timestamp; and
associating, by the language-based AI model, the set of event descriptors with a user transaction to update the consumer preference signal.

11. A system for generating consumer interest profiles based on event-related transactions, the system comprising:
a payment network configured to:
receive transaction data identifying a third-party merchant and a timestamp associated with a purchase made by a user at an event;
determine an event location associated with the third-party merchant by executing a fuzzy-matching algorithm against a location-merchant mapping database;
identify the event associated with the event location and timestamp by executing a temporally-constrained query against an event location calendar database to identify an event record;
retrieve event metadata associated with the event record;
transmit a query to a language-based artificial intelligence (AI) model, an event-type database to identify an event-type associated with the event location and the timestamp;
generate and store a consumer preference signal associating the user with the event record, event-type, and the event metadata; and
generate a personalized recommendation or offer for the event or a future event based on the consumer preference signal; and
a language-based AI model operatively coupled to the payment network, the language-based AI model configured to:
receive the query from the payment network;
execute the query against publicly available sources;
evaluate a relevance of retrieved results;
adaptively modify the query based on result sparsity or excess until converging on a set of event descriptors for the event location and timestamp; and
return an event-type associated with the event location and the timestamp.

12. The system of claim 11, wherein the language-based AI model is further configured to:
generate a hierarchical tag taxonomy for the user based on the event metadata, wherein the hierarchical tag taxonomy encodes a plurality of tags organized in a multi-level hierarchy proceeding from a broad event category to one or more specific event descriptors, and wherein each tag in the hierarchical tag taxonomy is associated with a machine-learning-maintained confidence score;
upon receipt of each new transaction corresponding to a new inferred event, update the hierarchical tag taxonomy by:
increasing a confidence score for each tag in the hierarchical tag taxonomy that is reinforced by the new inferred event; and
decreasing a confidence score for each pre-existing tag in the hierarchical tag taxonomy that is not reinforced by the new inferred event.

13. The system of claim 11, wherein the payment network is further configured to:
pseudonymize the consumer preference signal and store the consumer preference signal as a tokenized identifier.

14. A method for generating consumer interest profiles based on event-related transactions, the method comprising:
receiving, by a payment network, transaction data identifying a third-party merchant and a timestamp associated with a purchase made by a user at an event of a known event-type;
determining, by a language-based artificial intelligence (AI) model associated with the payment network, an event location associated with the third-party merchant based on a location-merchant mapping database;
identifying, by the language-based AI model associated with the payment network, the event and a participant associated with the event location and timestamp based on an event location calendar database;
retrieving, by the language-based AI model associated with the payment network, a sub-type descriptor associated with the participant from a participant-descriptor database;
generating and storing, by the payment network, a consumer preference signal associating the user with an identified participant and sub-type descriptor; and
generating, by the payment network, a personalized recommendation or offer for the event or a future event based on the consumer preference signal.

15. The method of claim 14, comprising pseudonymizing, by the payment network, the consumer preference signal and storing the consumer preference signal as a tokenized identifier.

16. The method of claim 14, comprising, by the language-based AI model associated with the payment network, generating a summary table for the user indicating a count of participants or sub-types attended over a time window for the known event-type.

17. The method of claim 14, comprising parsing, by the language-based AI model associated with the payment network, a sub-type label from public data or reviews of the participant, wherein the sub-type descriptor includes the sub-type label parsed from the public data or reviews.

18. The method of claim 14, wherein location-merchant mapping comprises address matching or name similarity scoring by the language-based AI model associated with the payment network.

19. The method of claim 14, further comprising generating, by the language-based AI model associated with the payment network, a hierarchical tag taxonomy for the user based on the identified participant and sub-type descriptor, wherein the hierarchical tag taxonomy encodes a plurality of tags organized in a multi-level hierarchy proceeding from a sub-type descriptor to the identified participant, and wherein each tag in the hierarchical tag taxonomy is associated with a machine-learning-maintained confidence score.

20. The method of claim 14, further comprising:
prompting the language-based AI model with the event location and the timestamp to generate a search query;
executing, by the language-based AI model, the search query to retrieve public event data;
evaluating, by the language-based AI model, a relevance of results using threshold criteria;
adaptively modifying, by the language-based AI model, the search query based on result sparsity or excess;
converging, by the language-based AI model, on a set of event descriptors for the event location and timestamp; and
associating, by the language-based AI model, the set of event descriptors with a user transaction to update the consumer preference signal.
